(19) United States
(12) Patent Application Publication
(10) Pub. No.: US 2009/0213335 A1
(43) Pub. Date: Aug. 27, 2009

(54) Image projecting system, image projecting method, computer program, and recording medium

(75) Inventors: Tetsujiro Kondo, Tokyo (JP); Hitoshi Mukai, Kanagawa (JP); Masanori Iwasaki, Kanagawa (JP); Kenji Tanaka, Kanagawa (JP); Tetsushi Kokubo, Kanagawa (JP); Hirofumi Hibi, Kanagawa (JP); Kazumasa Tanaka, Chiba (JP); Hiroyuki Morisaki, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/380,168

(22) Filed: Feb. 24, 2009

(30) Foreign Application Priority Data
Feb. 26, 2008 (JP) P2008-045214

(51) Int. Cl. G03B 21/14

(52) U.S. Cl. 353/30; 353/121

(57) ABSTRACT

An image projecting system is provided. The image projecting system includes a plurality of projector apparatuses, an observation apparatus, and a control apparatus. The projector apparatuses project images based on inputted image signals onto a screen so that the images are displaced relative to one another by a predetermined amount and superimposed. The observation apparatus observes luminance of an image region composed of a plurality of images projected onto the screen by the plurality of projector apparatuses. The control apparatus supplies the plurality of projector apparatuses with the image signals having an adjusted luminance value of each pixel for an image projected by each projector apparatus based on an observation result of the observation apparatus.

### CROSS REFERENCES TO RELATED APPLICATIONS

The present invention contains subject matter related to Japanese Patent Application JP 2008-045214 filed in the Japanese Patent Office on Feb. 26, 2008, the entire contents of which being incorporated herein by reference.

### BACKGROUND OF THE INVENTION

1. Field of the Invention

The present invention relates to an image projecting system and an image projecting method that are suitably applied to projecting images onto a screen using a plurality of projector apparatuses, a computer program applied to a processing method thereof, and to a recording medium that stores such computer program.

2. Description of the Related Art

In the past, to realize a large-screen display that has high resolution, a method of projecting a large image by arranging a plurality of projector apparatuses in a grid has been proposed.

FIG. 1 shows an example construction of an existing image projecting system 100 including a plurality of projector apparatuses. The image projecting system 100 includes N projector apparatuses, a screen 102 as a display screen for projected images, an observation unit 104 that observes the images projected onto the screen 102, and a control apparatus 5 that receives information observed by the observation unit 104 and supplies image signals to the projector apparatuses. However, in FIG. 1 only the projector apparatuses 101-1 to 101-4, 101-11 to 101-14, and 101-21 to 101-24 are shown. Each projector apparatus projects an image onto the screen 102 and by joining the images projected by the respective projector apparatuses, a single image is formed. In this way, one large image is formed on the entire screen 102. Note that in the following description, the image projected onto the screen 102 by one projector apparatus is referred to as a “projected image”. In FIG. 1, the projected image projected onto the screen 102 by the projector apparatus 101-12 is set as the “projected image 103-12”.

FIG. 2 is composed of three views of the image projecting system 100 that are a front view, a side view, and an upper view. The projected image 103-12 is highlighted for comparison with the projected images produced by the other projector apparatuses. In the past, when an image is projected onto the screen 102 using a plurality of projector apparatuses, parts (i.e., edge portions) of adjacent projected images overlap.

However, when an image is projected using the image projecting system 100, the “joins” between the adjacent projected images are conspicuous. For this reason, before an image is presented, preprocessing (calibration) is typically carried out to prevent the joins between adjacent projected images from being conspicuous.

The following two methods are known as representative types of preprocessing (calibration).

### (1) Geometric Correction

It is difficult to accurately lay out the projector apparatuses so that a plurality of projected images projected by adjacent projector apparatuses join up. For this reason, geometric conversion is carried out in advance on the image to be presented so that the plurality of projected images join up. FIGS. 3A and 3B are diagrams showing projected images when the screen 102 is set as an xy plane. In FIGS. 3A and 3B, the projected image 103-11 of the projector apparatus 101-11 and the projected image 103-12 of the projector apparatus 101-12 are extracted from the plurality of projected images. Here, it is assumed that grid patterns are displayed in the projected images 103-11, 103-12. The projector apparatuses 101-11, 101-12 are slightly displaced in the horizontal direction due to the positions in which the apparatuses have been set up.

FIG. 3A shows an example display of the projected images before geometric correction.

Before geometric correction, the grids of the projected images 103-11, 103-12 are displayed in a displaced state. For this reason, the horizontal lines and vertical lines in the images become crooked, which is not suitable.

FIG. 3B shows an example display of the projected images after geometric correction.

After geometric correction, the grids of the projected images 103-11, 103-12 are displayed on top of one another. The horizontal lines and vertical lines in the images are displayed without being crooked.

In this way, by carrying out geometric correction on the images to be projected by the respective projector apparatuses, an image can be displayed on the entire screen 102 without displacements.

### (2) Luminance/Color Correction

Even for projector apparatuses of the same model, due to fluctuations in the characteristics of the internal optical elements, the projector lamp, and the like, there can be differences between individual apparatuses in the intensity of the outputted light and the intensity balance of the RGB colors. Also, in regions where the projected images projected by adjacent projector apparatuses are superimposed, since the intensities of light from two projector apparatuses are added, such regions will become extremely bright compared to the periphery thereof.

FIG. 4 is a photograph showing one example of the fluctuations in luminance and colors between the projected images projected using the image projecting system 100. In a state where the projector apparatuses are disposed in a tile pattern and the same input (white light, where (R, G, B)=(255, 255, 255)) is used for the respective projector apparatuses, part of the image projected on the screen is picked up by the observation unit. Each rectangular region in FIG. 4 corresponds to one projector apparatus. Here, it can be seen that there are fluctuations in luminance and color between the projected image 103-12 and adjacent projected images. It can also be seen that there are differences in the luminance between projector apparatuses and differences in color even for the same white color. Finally, there are fluctuations in luminance and color even within the projected image of the same projector apparatus.

For this reason, to even out the imbalances in luminance, luminance correction is carried out as shown in FIGS. 5A and 5B. FIGS. 5A and 5B are diagrams where the luminance L of the images projected onto the screen 102 from the projector apparatuses 101-11, 101-12 is shown on the vertical axis and the xy plane on the screen 102 is shown on the horizontal axis.

FIG. 5A shows an example of the luminance of projected images before luminance correction.

Before luminance correction, the luminances of the images projected from the projector apparatuses 101-11, 101-12 are shown by curves. Since the luminance increases at the position where adjacent projected images are superimposed, a bright line appears on the screen.

FIG. 5B shows an example of luminance of projected images after luminance correction.

After luminance correction, the luminances of the images projected from the projector apparatuses 101-11, 102-12 are shown by straight lines. The projected images before luminance correction are shown by broken lines for comparison purposes. Since the increased luminance at a position where adjacent projected images are superimposed is substantially matched to a flattened luminance, a bright line does not appear on the screen.

Aside from the technologies described above, various other calibration technologies have been proposed.

Japanese Unexamined Patent Application Publication No. 2006-109168 discloses a technology for displaying images projected from three projector apparatuses as one image on a screen.

Japanese Unexamined Patent Application Publication No. 2007-251294 discloses a technology that projects and superimposes a color correcting image to correct nonuniformity in a color distribution produced in images when a plurality of images are projected so as to be adjacent to one another.

### SUMMARY OF THE INVENTION

However, the existing image projecting system 100 has the following problems.

### (1) Vulnerability to Differences Between Individual Projector Apparatuses

Regarding calibration that carries out correction of the luminance and color, most existing image projecting systems proposed thusfar carry out correction so as to make the characteristics of projector apparatuses in a plurality of projector apparatuses match the projector apparatus with the most unsuitable characteristics (i.e., with the lowest luminance). This will now be described with reference to FIGS. 6A and 6B.

FIGS. 6A and 6B show examples of the luminances (for a white monochrome image) of images projected onto the screen by seven projector apparatuses (referred to as the first to seventh projector apparatuses).

FIG. 6A shows an example of the luminances of images projected by the respective projector apparatuses before the characteristics are matched. In this example, the luminance of the image projected by the fifth projector apparatus is the lowest.

FIG. 6B shows an example of the luminances of images projected by the respective projector apparatuses after the characteristics have been matched. The luminances before the characteristics are matched are shown by broken lines for comparison purposes.

Here, it can be understood that since the luminances of the images projected by the first to fourth projector apparatuses and the sixth and seventh projector apparatuses are matched with the luminance of the image projected by the fifth projector apparatus, there is a fall in overall luminance.

That is, the performance of the image projecting system as a whole is influenced by the performance of individual projector apparatuses. This means that the luminance performance of the image projecting system is dependent on differences between individual projector apparatuses and is susceptible to a fall in luminance.

### (2) Vulnerability to Breakdown of Projector Apparatuses

In addition, in an existing image projecting system, if one projector apparatus breaks down and the projector lamp goes out while images are being projected, no image will be displayed on the region of the screen where such projector apparatus projected an image. This results in part of the image projected on the screen becoming blank. Even if it only takes a short time to repair the broken projector apparatus, depending on the application to which the image projecting system is put (for example, monitoring images for security purposes), this can still represent a large drop in the quality of the image projecting system.

It is desirable to make the luminance of projected images uniform when images projected by a plurality of projector apparatuses are superimposed and presented on a screen.

According to an embodiment of the present invention, a plurality of projector apparatuses project images based on an inputted image signal onto a screen so that the images are displaced relative to one another by a predetermined amount and superimposed. Luminances of an image region composed of a plurality of the images projected onto the screen are observed. A luminance value of each pixel for an image to be projected by each projector apparatus is adjusted based on an observation result, and such luminance values are supplied to the plurality of projector apparatuses. A pixel in the image region is produced by superimposing corresponding pixels in images projected by adjacent projector apparatuses in the plurality of projector apparatuses, and a length of one edge of each projected image is n times a distance between the adjacent projector apparatuses (where n is an integer of two or higher).

In this way, since each pixel in the image projected onto the screen is produced by superimposing images projected by a plurality of projector apparatuses, it is possible to keep the luminance of the entire screen uniform.

According to an embodiment of the present invention, since images projected onto a screen by a plurality of projector apparatuses are superimposed, the luminance of the image on the entire screen is made uniform. Also, even if one or more projector apparatuses breaks down and becomes unable to project an image, other projector apparatuses that are adjacent to the broken projector will continue projecting images, resulting in the effect that it is possible to prevent blanks from appearing in the image projected onto the screen.

### BRIEF DESCRIPTION OF THE DRAWINGS

FIG. 1 is a diagram showing one example of the external construction of an existing image projecting system;

FIG. 2 is a three-view diagram showing one example of the layout of projector apparatuses in the existing image projecting system and one example of a projected image;

FIGS. 3A and 3B are diagrams showing an example of calibration (geometric correction);

FIG. 4 is a diagram showing an example of fluctuations in luminance and color between projected images;

FIGS. 5A and 5B are diagrams showing an example of calibration (luminance correction);

FIGS. 6A and 6B are diagrams showing examples of luminance before and after correction for existing projector apparatuses;

FIG. 7 is a diagram showing one example of the external construction of an image projecting system according to a first embodiment of the present invention;

FIGS. 8A to 8C construct a three-view diagram showing one example of the layout of projector apparatuses in the image projecting system according to the first embodiment of the present invention and one example of a projected image;

FIG. 9 is a block diagram showing one example of the internal configuration of the image projecting system according to the first embodiment of the present invention;

FIG. 10 is a diagram showing an example where pixels in a projected image are expressed on XY coordinate axes according to the first embodiment of the present invention;

FIG. 11 is a diagram showing an example of correspondence between various variables for the projector apparatuses, the planes, and the pixel positions according to the first embodiment of the present invention;

FIGS. 12A to 12C are graphs showing examples of the luminance distribution of projected images according to the first embodiment of the present invention;

FIG. 13 is a flowchart showing an example of an image projecting processing according to the first embodiment of the present invention;

FIG. 14 is a flowchart showing an example of an image presentation processing according to the first embodiment of the present invention;

FIGS. 15A and 15B are diagrams showing examples of luminances before and after correction for each projector apparatus according to the first embodiment of the present invention;

FIGS. 16A to 16D are diagrams showing example constructions for superimposing projected images using a plurality of projector apparatuses;

FIGS. 17A to 17D are diagrams showing example displays of projected images when the projected images of projector apparatuses are superimposed;

FIG. 18 is a graph showing one example of the standard deviations of color values x, y when projected images of projector apparatuses are superimposed;

FIG. 19 is a diagram showing an example of how color values are measured;

FIGS. 20A and 20B are diagrams showing examples of color values x, y in a case where projected images are not superimposed;

FIGS. 21A and 21B are diagrams showing examples of color values x, y in a case where projected images of four adjacent projector apparatuses are superimposed;

FIGS. 22A and 22B are diagrams showing examples of color values x, y in a case where projected images of nine adjacent projector apparatuses are superimposed;

FIGS. 23A and 23B are diagrams showing examples of color values x, y in a case where projected images of sixteen adjacent projector apparatuses are superimposed;

FIGS. 24A and 24B are diagrams showing examples of color values x, y in a case where projected images of twenty-five adjacent projector apparatuses are superimposed;

FIG. 25 is a graph showing one example of the relationship between the color values x, y and the number of projector apparatuses that superimpose projected images;

FIG. 26 is a diagram showing an example display where an image is projected by a single projector apparatus in each region;

FIG. 27 is a diagram showing an example display where an image is projected by four projector apparatuses in a region;

FIG. 28 is a diagram showing an example of the external construction of an image projecting system according to a second embodiment of the present invention;

FIG. 29 is a block diagram showing one example of the internal configuration of the image projecting system according to the second embodiment of the present invention;

FIG. 30 is a block diagram showing one example of the internal configuration of a projector apparatus according to the second embodiment of the present invention;

FIGS. 31A to 31D are diagrams showing examples where images are projected by a projector apparatus according to the second embodiment of the present invention;

FIGS. 32A to 32D are diagrams showing examples of where images are projected by a projector apparatus according to the second embodiment of the present invention;

FIGS. 33A to 33D are diagrams showing an example of a transition in the phase patterns of projector apparatuses according to the second embodiment of the present invention;

FIGS. 34A to 34D are diagrams showing an example of a transition in the phase patterns of the projector apparatuses according to the second embodiment of the present invention;

FIGS. 35A to 35C are diagrams showing an example layout of projector apparatuses according to another embodiment of the present invention; and

FIGS. 36A to 36C are diagrams showing an example of projected images that are superimposed according to another embodiment of the present invention.

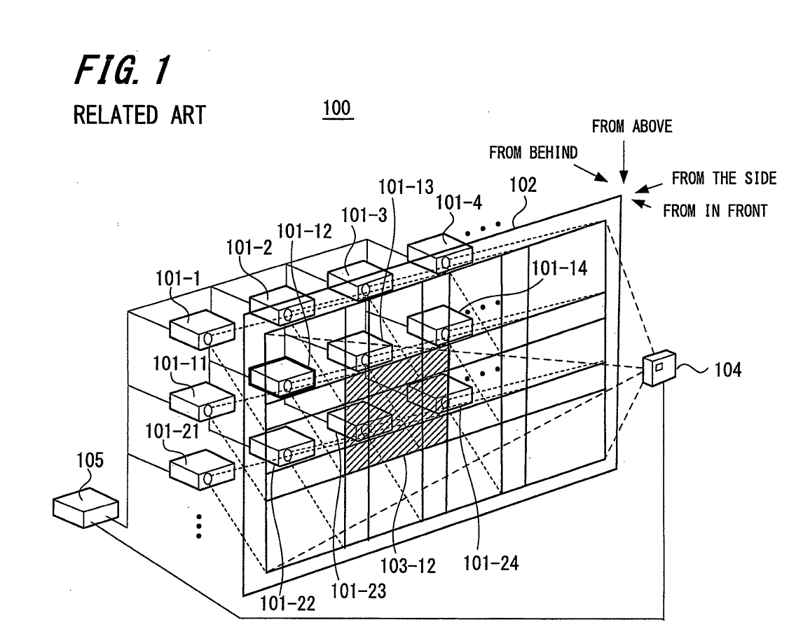

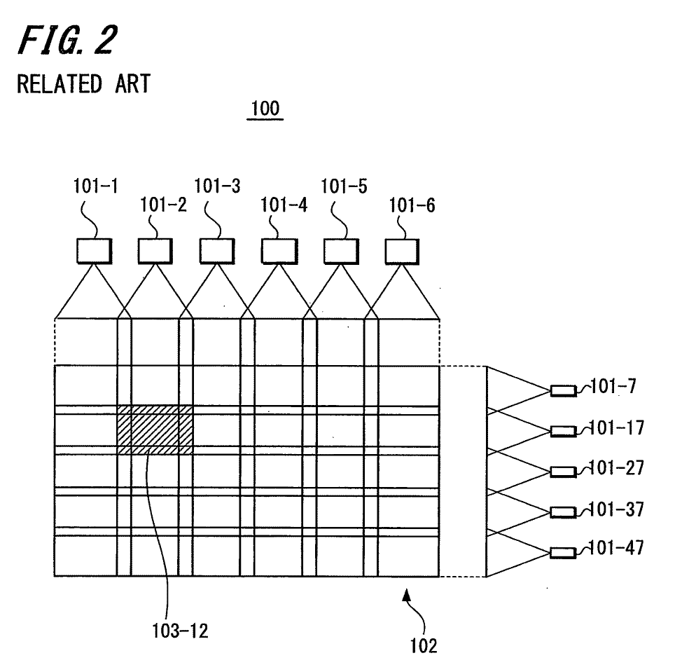

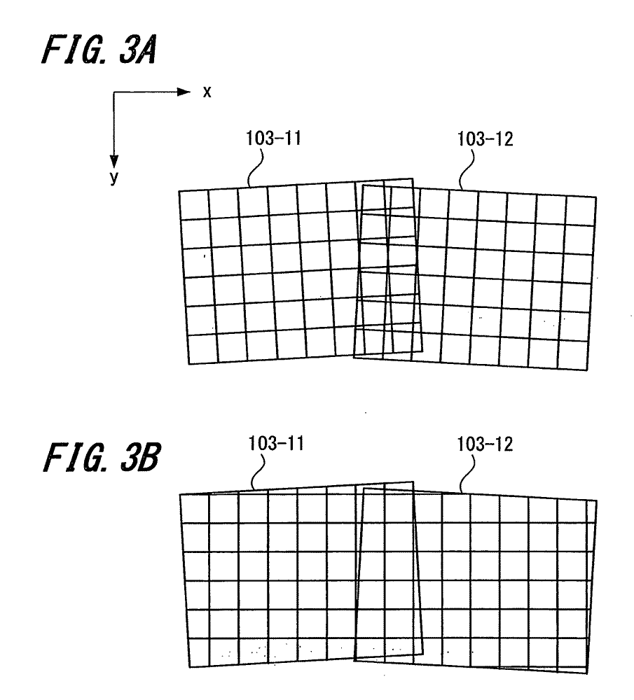

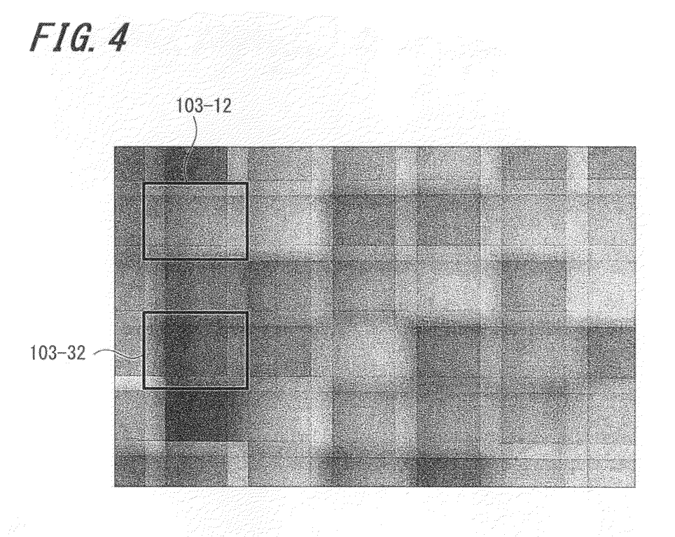

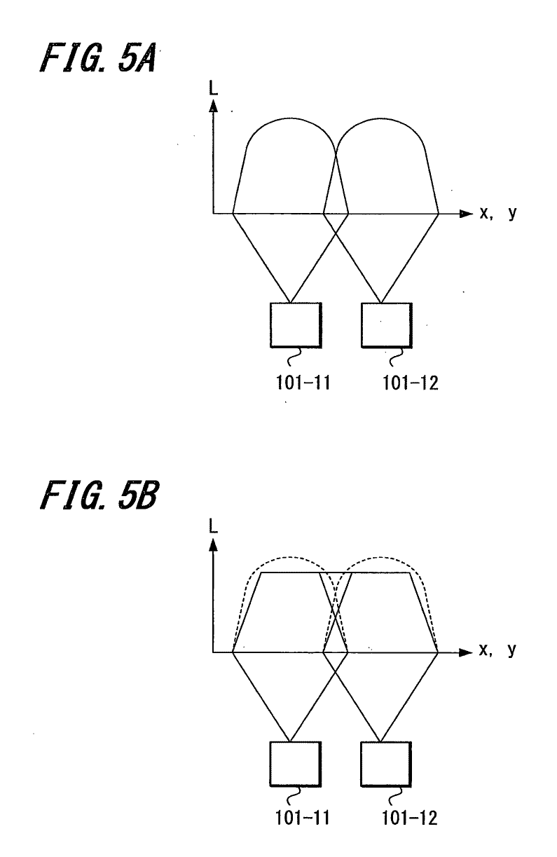

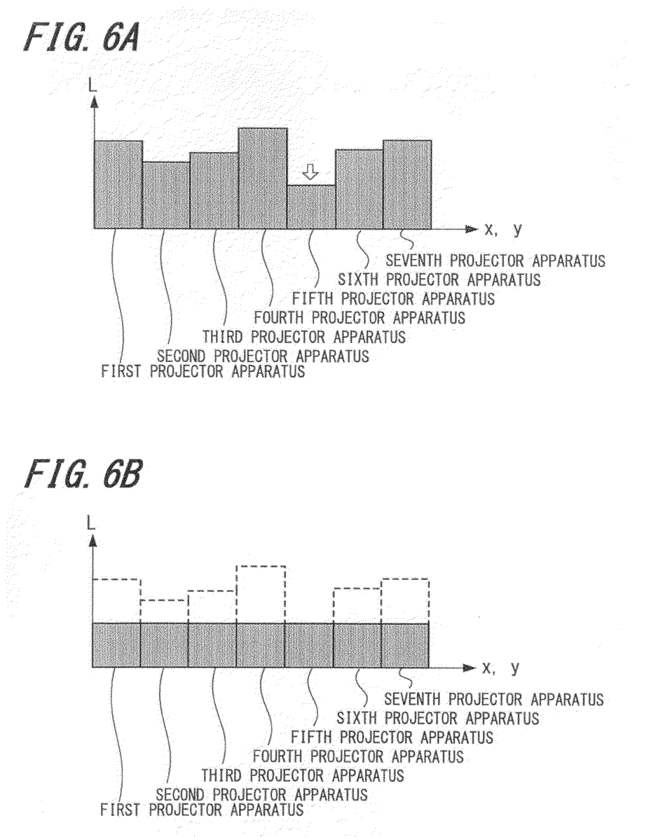

### DESCRIPTION OF THE PREFERRED EMBODIMENTS

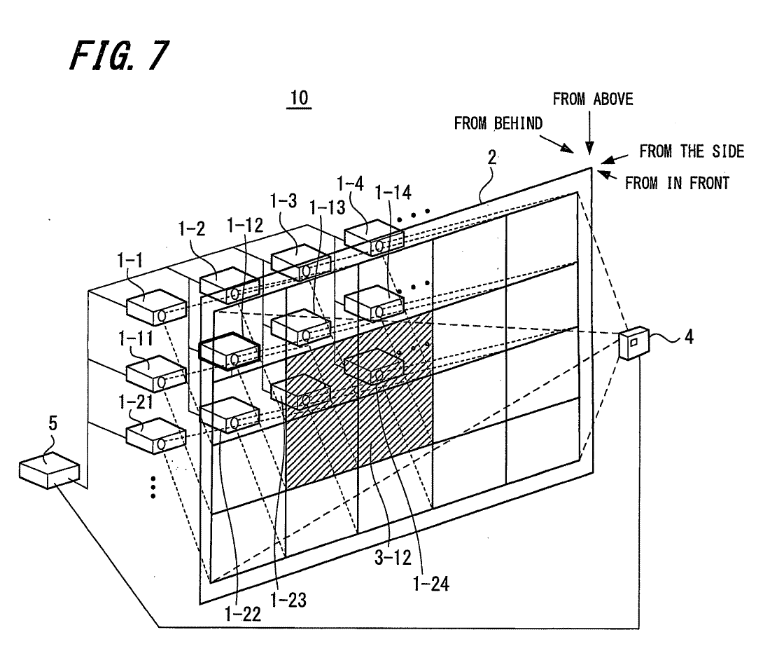

A first embodiment of the present invention will now be described with reference to FIGS. 7 to 27. The present embodiment is described for an example where the present invention is applied to an image projecting system 10 that can display a high-definition image on a screen with uniform luminance by superimposing images projected using a plurality of projector apparatuses.

FIG. 7 shows an example construction of an image projecting system 10 including a plurality of projector apparatuses. The image projecting system 10 supplies image signals to N projector apparatuses 1-1 to 1-N with the same projection performance. In the present embodiment, the case where N=35 projector apparatuses will be described.

The image projecting system 10 according to the present embodiment includes the N projector apparatuses, a screen 2 as a display screen for the projected images, an observation unit 4 for observing the image projected onto the screen 2, and a control apparatus 5 that receives information observed by the observation unit 4 and supplies an image signal to each projector apparatus. However, FIG. 7 has been simplified and only the projector apparatuses 1-1 to 1-4, 1-11 to 1-14, and 1-21 to 1-24 are shown.

The N projector apparatuses are disposed in a grid at predetermined intervals and project images based on the inputted image signals onto the screen 2 so that the images are superimposed at positions that are displaced by a predetermined distance. Each projector apparatus projects part of the image on the screen 2 so that as a whole, a single image is formed. In FIG. 7, the image projected onto the screen 2 by the projector apparatus 1-12 is referred to as the “projected image 3-12”.

The observation unit 4 observes the luminance of an image region composed of the images projected on the screen 2. The observation unit 4 may be disposed behind the screen 2 instead of in front of the screen 2.

The control apparatus 5 adjusts the luminance values of the respective pixels for the image projected by the projector apparatuses based on the observation result of the observation unit 4 and supplies the luminance values to the plurality of projector apparatuses.

Any pixel in the image region is produced by superimposing corresponding pixels in images projected by adjacent projector apparatuses in the plurality of projector apparatuses. The length of one edge of a projected image is n (where n is an integer of two or higher) times the distance between the projector apparatuses that are disposed adjacent to one another.

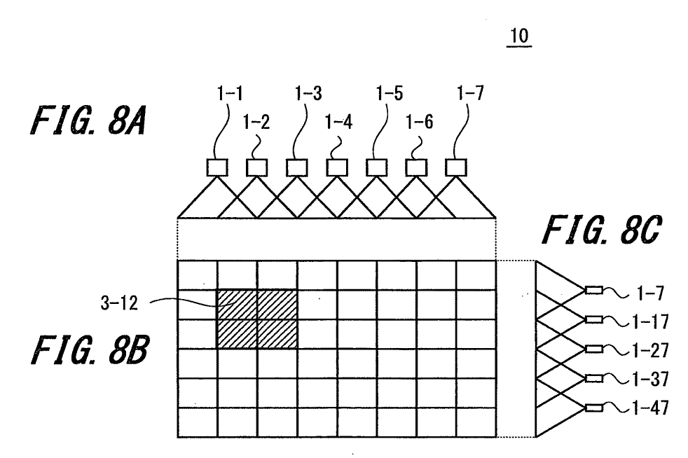

FIGS. 8A to 8C construct a three-view diagram of the image projecting system 10. The projected image 3-12 has been highlighted for comparison with the projected images produced by other projector apparatuses.

FIG. 8A shows an example of the image projecting system 10 when viewed from above.

FIG. 8B shows an example of the image projecting system 10 when viewed from in front.

FIG. 8C shows an example of the image projecting system 10 when viewed from the side.

The N projector apparatuses project images onto the screen so that the projected images thereof are respectively displaced by a length that is 1/n times the length of one edge of a projected image. That is, if the distance between projector apparatuses is set as “1”, “n” is a multiple of the length of one edge of the projected image produced by one projector apparatus. For example, each projector apparatus is disposed so that the widths (i.e., the widths in both the horizontal and vertical direction) of the image projected by one projector apparatus are substantially double (or another integer multiple such as triple or quadruple) the interval at which the projector apparatuses are disposed. This means that aside from the edge portions where there is no adjacent projector apparatus, all of the pixels are produced by superimposed light from four different projector apparatuses.

A region where projected images from adjacent projector apparatuses are superimposed extends across the entire screen 2. In addition, at every position in a projected image aside from the edge portions of the image projected onto the screen 2, images (i.e., light) projected by a plurality of projector apparatuses are superimposed.

In the past, when images were projected onto the screen 2 using a plurality of projector apparatuses, the edge portions of adjacent projected images were superimposed on one another. However, an embodiment of the present invention does not simply superimpose the edge portions of projected images as in the past. According to the present embodiment, the projected image of one projector apparatus is superimposed with the projected images of four projector apparatuses (for example) that are adjacent above, below, to the left, and to the right of such projector apparatus.

However, in the image projecting system 10, there is no limit on the number of projector apparatuses that superimpose projected images. It is also possible to construct an image projecting system where the width of the projected image of each projector apparatus is further increased and the light that composes one pixel is produced by four or more projector apparatuses, such as nine, sixteen, or twenty-five projector apparatuses. This will be described later along with test results for the superimposing of projected images.

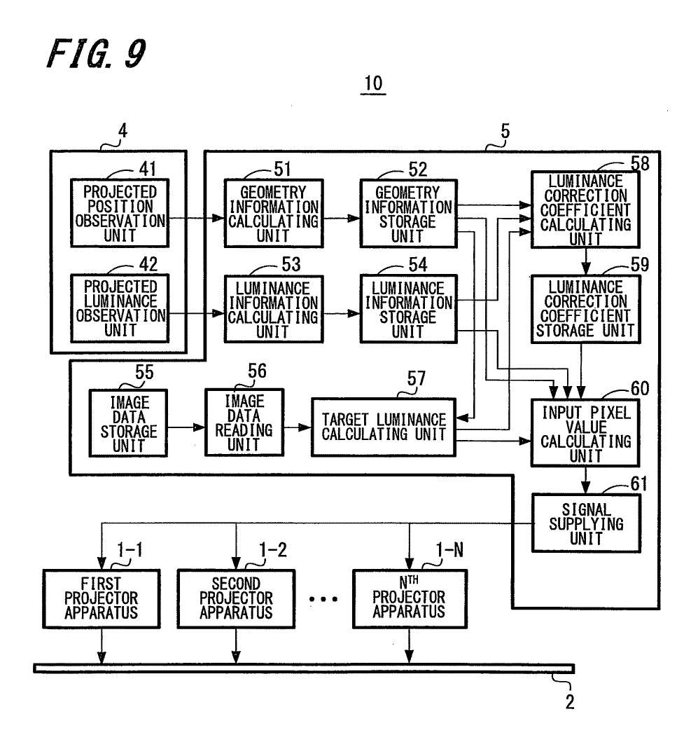

FIG. 9 is a block diagram showing an example of the internal configuration of the image projecting system 10.

A camera is used as the observation unit 4, including an optical lens system, not shown, an image pickup element that converts image light taken in via the optical lens system at predetermined shutter timing to an electric signal, a storage unit that stores the converted electric signal as still image data or video data, and a transfer processing unit that is connected to the control apparatus 5 and transfers the still image data or the video data stored in the storage unit. However, the observation unit 4 may be a camera capable of picking up video images or still images, for example, or a luminance meter that measures luminance.

The observation unit 4 includes a projected position observation unit 41 that observes, based on the still image data or video data stored in the storage unit, the projected positions of pixels that compose the image region where the projector apparatuses project image light onto the screen 2 and a projected luminance observation unit 42 that observes the luminance of the image region on the screen 2 onto which the projector apparatuses project images. The observation results of the projected position observation unit 41 and the projected luminance observation unit 42, i.e., information on the projected position and projected luminance obtained for each projector apparatus is supplied to the control apparatus 5. However, the observation unit 4 may be constructed so as to include a color meter as a color observing unit that observes the color (the hue and chroma) of an image projected on the screen 2.

The control apparatus 5 includes a geometry information calculating unit 51 that calculates, as “geometry information”, the positions of pixels that construct a projected image for each projector apparatus based on the projected positions of pixels in the image region observed by the projected position observation unit 41 and a geometry information storage unit 52 that is a storage region for temporarily storing the geometry information calculated by the geometry information calculating unit 51.

The control apparatus 5 also includes a luminance information calculating unit 53 that calculates, as “luminance information”, the luminances of respective pixels in the image region on the screen from the luminance and position information in the image region observed by the projected luminance observation unit 42 and a luminance information storage unit 54 that is a storage region for temporarily storing the luminance information calculated by the luminance information calculating unit 53.

The control apparatus 5 also includes an image data storage unit 55 that stores original image data to be projected by the projector apparatuses, an image data reading unit 56 that reads image data from the image data storage unit 55, and a target luminance calculating unit 57 that sets, based on the image data read by the image data reading unit 56, a luminance that is a target for the image region where images are projected onto the screen 2 as a target luminance and calculates the target luminance. The target luminance calculating unit 57 is supplied with the geometry information stored in the geometry information storage unit 52. The target luminance calculating unit 57 sets an appropriate target luminance for each pixel based on the supplied geometry information so as to fall within a range of a maximum value and a minimum value for the luminance of the projected images produced by the plurality of projector apparatuses. That is, a target luminance is calculated for each projector apparatus.

The control apparatus 5 further includes a luminance correction coefficient calculating unit 58 that determines, as luminance correction coefficients, allocations of luminance for the projected images of the respective projector apparatuses for the geometry information stored in the geometry information storage unit 52, the luminance information stored in the luminance information storage unit 54, and the target luminances of the image region set by the target luminance calculating unit 57. The control apparatus 5 further includes a luminance correction coefficient storage unit 59 that is a storage region that temporarily stores the luminance correction coefficients calculated by the luminance correction coefficient calculating unit 58.

The control apparatus 5 also includes an input pixel value calculating unit 60 that calculates input pixel values based on the geometry information stored in the geometry information storage unit 52, the luminance information stored in the luminance information storage unit 54, the target luminances calculated by the target luminance calculating unit 57, and the luminance correction coefficients stored in the luminance correction coefficient storage unit 59.

The input pixel value calculating unit 60 determines the target projected luminance of the projected image of each projector apparatus based on a luminance correction coefficient determined by the luminance correction coefficient calculating unit 58 and the target luminances. In addition, the input pixel value calculating unit 60 calculates the pixel values of the images projected by each projector apparatus based on the determined target projected luminance, the position information, and the luminance information.

The control apparatus 5 also includes a signal supplying unit 61 that generates a control signal that controls a projector apparatus and an image signal based on the input pixel values calculated by the input pixel value calculating unit 60 and supplies the signals to the respective projector apparatuses.

The signal supplying unit 61 receives from the input pixel value calculating unit 60 projector identification numbers of projector apparatuses to be supplied with signals and the input image data to be supplied, and supplies image signals to the N projector apparatuses 1-1 to 1-N. In the present embodiment, the case where N=35 projector apparatuses is described. The projector apparatuses 1-1 to 1-N adjust the luminance based on the image signal supplied from the signal supplying unit 61 and project an image onto the screen 2.

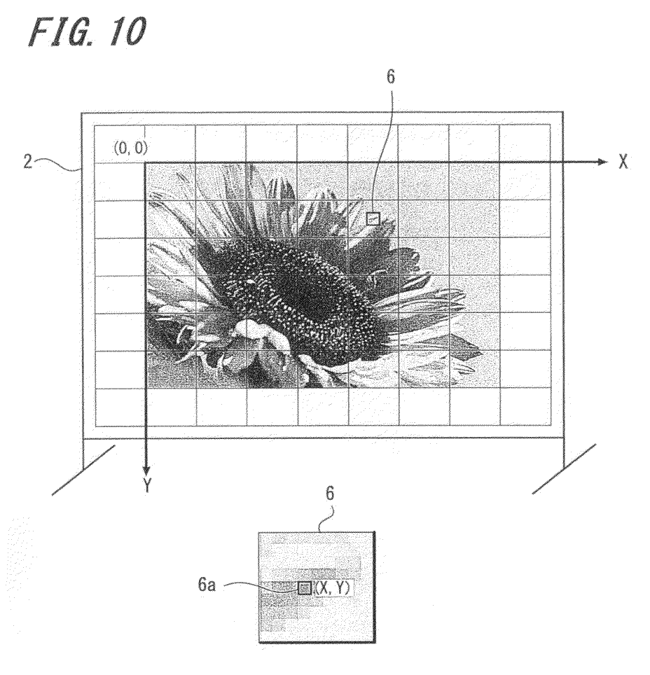

Next, an example of image processing by the control apparatus 5 will be described with reference to FIGS. 10 to 14.

FIG. 10 shows a pixel position in an image projected onto the screen 2.

Hereinafter, a region, aside from the edge portions of the screen 2, where light from the respective projector apparatuses is superimposed (for example, a region where light from four different projector apparatuses is superimposed) is referred to as the “image presentation region”.

XY coordinate axes are set on the screen 2 and the position of the origin (0,0) is determined. For this reason, pixel positions on the screen 2 are uniquely defined relative to the origin. When a desired image is projected onto the image presentation region, the positions that correspond to the pixels that construct the image projected onto the screen 2 are expressed as the pixel positions (X,Y). Here, the position of the pixel 6a included in the enlarged region 6 produced by enlarging part of the image projected on the screen 2 is determined as the pixel position (X,Y). In the present embodiment, the pixel 6a is projected by pixels in images projected by four adjacent projector apparatuses.

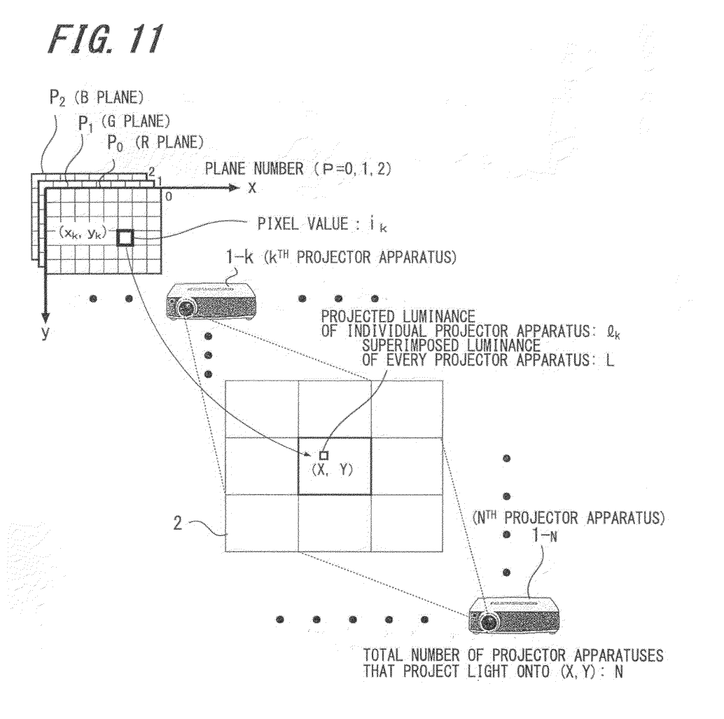

FIG. 11 is a diagram useful in showing an example of various variables used by the image projecting system 10 for the pixel position (X,Y) found in FIG. 10.

(1) First Calibration: Calculate Correspondence Between (xₖ,yₖ) and (X,Y)

Here, the total number of projector apparatuses that project light onto the pixel position (X,Y) is set as m(=n²). Here, for the k^{th} projector apparatus that projects light on the pixel position (X,Y) in the total of m projector apparatuses, the pixel position on each plane corresponding to the pixel position (X,Y) is expressed as the “corresponding pixel position (xₖ,yₖ)”. The correspondence between the number k for identifying a projector apparatus and an ordinal number of the projector apparatus in the total of N projector apparatuses present in the image projecting system will differ at different pixel positions (X, Y). The relationships shown by the relational expressions (1) to (4) for the pixel position (X,Y) in a projected image and the corresponding pixel position (xₖ,yₖ) on the R plane, the G plane, and the B plane projected by the respective projector apparatuses are measured in advance.

X=fₓ(xₖ, yₖ, k) (1)

Y=f_{y}(xₖ, yₖ, k) (2)

xₖ=gₓ(X, Y, k) (3)

yₖ=g_{y}(X, Y, k) (4)

X, Y, xₖ, and yₖ are functions that are uniquely determined for every combination of a pixel position (X, Y) and a projector apparatus number k. Such functions (X, Y, xₖ, and yₖ) are referred to as the “geometry information” mentioned earlier. Note that Expression (1) and Expression (3), and Expression (2) and Expression (4) are inverse functions.

### (2) Second Calibration: Calculate Luminance for Pixel Position (X,Y) on the Screen 2 for Input Pixel Value

When the pixel value iₖ is inputted on the p^{th} plane of a panel of the k^{th} projector apparatus (for a color image, one of the R plane (p=0), G plane (p=1), B plane (p=2)), the luminance to be observed at the pixel position (X,Y) on the screen is calculated as lₖ, and the relationships shown by the relational expressions (5) and (6) are measured in advance.

Λₖ=h(X, Y, k, p, iₖ) (5)

iₖ=h⁻¹(X, Y, k, p, Λₖ) (6)

lₖ, iₖ are functions that are uniquely determined for every combination of a pixel position (X,Y), a projector apparatus number k for identifying an individual projector apparatus, and a plane number p. Note that Expressions (5) and (6) are inverse functions.

These functions (lₖ,iₖ) are referred to as the “luminance information” mentioned earlier. According to Expression (5), when the values 0 (minimum output), 1, 2, 3, . . . , 255 (maximum output) are inputted into the corresponding pixel positions (xₖ,yₖ) on the R plane, the G plane, and the B plane, the brightness of the measured pixel position (X,Y) is found in candelas.

For the pixel position (X,Y), the luminance L of the pixel position is the total of the projected luminance of every projector apparatus that projects light onto such pixel position. This is expressed in Expression (7).

$$L = {\sum }_{k}^{ } {l}_{k} \qquad ( 7 )$$

The target luminance to be projected onto the pixel position (X,Y) on the screen is expressed as L_{T} and is calculated by the input pixel value calculating unit 60. L_{T} is calculated according to Expression (8) using the pixel value I of the presentation image at such position and a gamma value γ set in advance at an appropriate value. The gamma value is set in advance so that the value calculated by Expression (8) falls within the range of a maximum value and a minimum value for the luminance of the projected image produced by a plurality of projector apparatuses.

L_{T}=I^{γ} (8)

There are a plurality of combinations of input pixel values iₖ (where k=1, 2, . . . , m) into the projector apparatuses that are required to realize the target luminance L_{T}. For this reason, it may be necessary to determine allocations of the luminance for each projector apparatus, that is, how much of the luminance L_{T} is to be projected by the respective projector apparatuses. Such allocations are referred to as the “luminance correction coefficients” and when written as w(X,Y,k,p), the target luminance L_{T} is expressed as shown in Expression (9). Each luminance correction coefficient is expressed as a real number from 0 to 1, and the total of the luminance correction coefficients is 1.

$${L}_{T} = {\sum }_{k}^{ } w ( X , Y , k , p ) {L}_{T} \qquad ( 9 )$$

### (3) Third Calibration: Calculate Allocation of Luminance for Each Projector Apparatus

A luminance correction coefficient is a uniquely determined constant for every combination of a pixel position (X,Y), a projector apparatus number k, and a plane number p. The luminance correction coefficients may need to be determined in advance in accordance with a maximum value l_{k,max} that can be produced by each projector apparatus at each position (X, Y) on the screen or in accordance with the maximum value l_{k,max} and the target luminance L_{T}. For example, when proportional allocations are simply used in accordance with the luminances of the respective projector apparatuses, the luminance correction coefficients are determined using Expressions (10) and (11).

$$\begin{matrix}{l}_{k , max} = h ( X , Y , k , p , 255 ) & ( 10 ) \\ w ( X , Y , k , p ) = \frac{{l}_{k , max}}{{\sum }_{k}^{ } {l}_{k , max}} & ( 11 )\end{matrix}$$

In the image projecting system according to the present embodiment, light projected from a plurality of projector apparatuses is incident on each pixel on the screen 2. The intensity of the projected light incident from each projector apparatus can be set with some freedom (i.e., a variety of intensity allocations are conceivable). Such freedom can be appropriately determined in accordance with the conditions and intended purpose. To determine the freedom, the luminance correction coefficients are calculated as one of the design parameters of the image projecting system. In the present embodiment, for a pixel in the image region on the screen, the allocations of the luminance in the images of respective projector apparatuses that project light onto such pixel can be optionally determined by changes based on the luminance correction coefficients.

For example, when the target luminance of the pixel position (X,Y) is 800 candelas, if the output of a first projector apparatus is low, a case where only 100 candelas of luminance are obtained can be imagined. In such case, it is possible to achieve the target luminance of 800 candelas by setting the luminance of a second projector apparatus at 230 candelas, the luminance of a third projector apparatus at 230 candelas, and the luminance of a fourth projector apparatus at 240 candelas. In this way, by supplementing the luminance using a plurality of projector apparatuses, it is possible to avoid a situation where the luminance falls in part of the image on the screen.

The pixel value iₖ to be inputted into the k^{th} projector apparatus for a target luminance L_{T} is calculated by the input pixel value calculating unit 60 according to Expressions (12) and (13).

Λₖ=w(X, Y, k, p)L_{T} (12)

iₖ=h⁻¹(gₓ(X, Y, k), g_{y}(X, Y, k), k, p, Λ_{T}) (13)

Here, when iₖ is a real number that includes a decimal point, such value is rounded to the nearest integer. The value iₖ is also determined so as not to exceed the range where 0≦iₖ≦255.

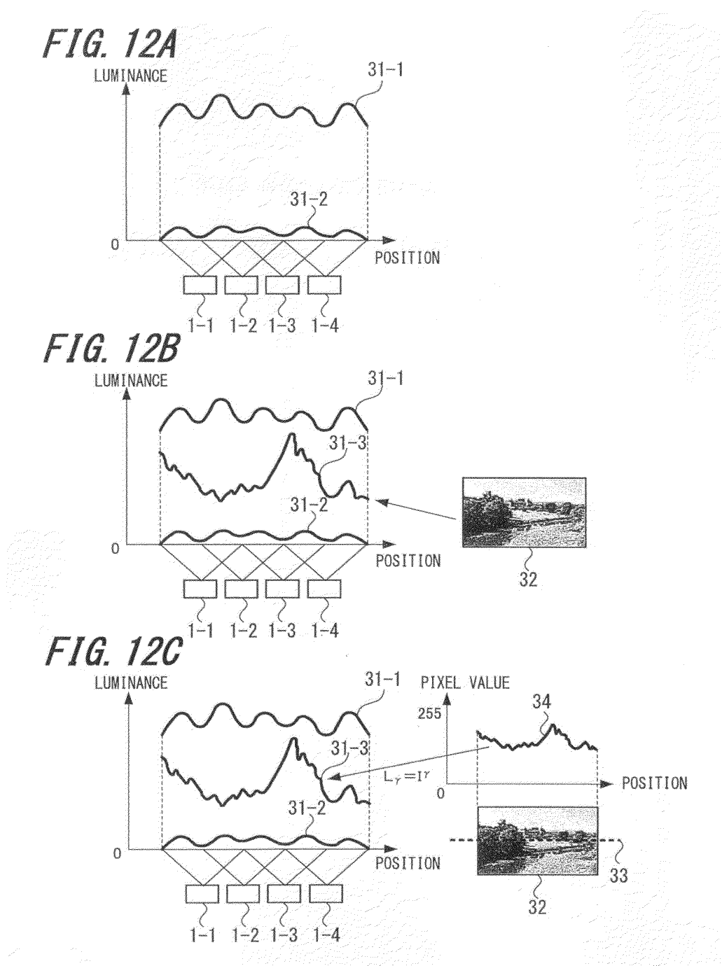

The target luminances will now be described with reference to FIGS. 12A to 12C. FIGS. 12A to 12C show an example of a luminance distribution for the setup positions of the projector apparatuses 1-1 to 1-4.

The target luminance is uniquely calculated for each position (i.e., each pixel) on the screen from a pixel value in the input image data to be projected using the image projecting system. Note that the expression “uniquely calculated” refers to the target luminance being automatically determined by calculation once Expression (8) has been provided. However, there is no unique way of determining the gamma value in Expression (8).

FIG. 12A shows a luminance distribution 31-1 on the screen 2 for a case where each projector apparatus projects at maximum output and a luminance distribution 31-2 on the screen 2 for a case where each projector apparatus projects at minimum output.

FIG. 12B shows an example of the luminances of the image to be presented on the screen 2.

If the luminance of the image 32 to be presented is within the range of the minimum output and the maximum output for the luminance projected by the projector apparatuses, it is possible to project any luminance. This means that it is possible to calculate the luminance to be projected by each projector apparatus in accordance with the image 32 to be presented. Luminances to be projected that are determined by the image 32 to be presented are expressed as “target luminances”. The luminance distribution 31-3 is a luminance distribution that expresses target luminances.

FIG. 12C shows an example of calculating target luminances.

A horizontal line 33 at any position is designated for the image 32 to be presented. In the actual processing, first the luminance values on a cross-section at every position from the top to the bottom of the image 32 are observed. After this, the gamma value is determined so that the target luminance is within a range of the minimum output and the maximum output at every position. When the target luminance is not within the range of the minimum output and the maximum output, the gamma value is determined having accepted that there will be some deterioration in image quality. The pixel values to be determined from the horizontal line 33 are determined as shown by a pixel value distribution 34. By multiplying the pixel value distribution 34 by a gamma value set in advance, the target luminances L_{T} (i.e., the respective pixel values in the image data) are calculated.

In the image projecting system 10 according to the present embodiment, there are no limitations on the method of determining the target luminance. It is possible for the user to set the target luminance in accordance with a variety of aims. For example, by setting a high target luminance, a user who likes screens with a high overall brightness can increase the overall brightness of the projected images. On the other hand, when images are projected with a low overall brightness, moody images can be produced. In such case, by setting a low target luminance, the screen as a whole can be made darker. For example, on a monitor connected to a computer or a television receiver, the adjustment parameter called “brightness” is available t,o the user and by changing such adjustment parameter in accordance with the user's preferences, it is possible to adjust the brightness of images. The target luminances determined in the image projecting system 10 are a parameter that is used in the same way as such adjustment parameter. In this way, the specific values expressed in Expression (8) can be determined in accordance with the user's aim and preferences. The image projecting system 10 further includes an operation unit, not shown, for changing the target luminances (as examples, a remote control apparatus or an adjustment knob).

The expression “gamma” refers to a value for converting the respective pixel values (0 to 255) in the image data to luminance values (candela values in a range of several tens to several tens of thousands) observed on the screen 2. In the image projecting system 10 according to the present embodiment, the gamma value is calculated in advance at an appropriate value so that the target luminances obtained by the first to third calibrations fall within the range of the luminance distributions 31-1, 31-2.

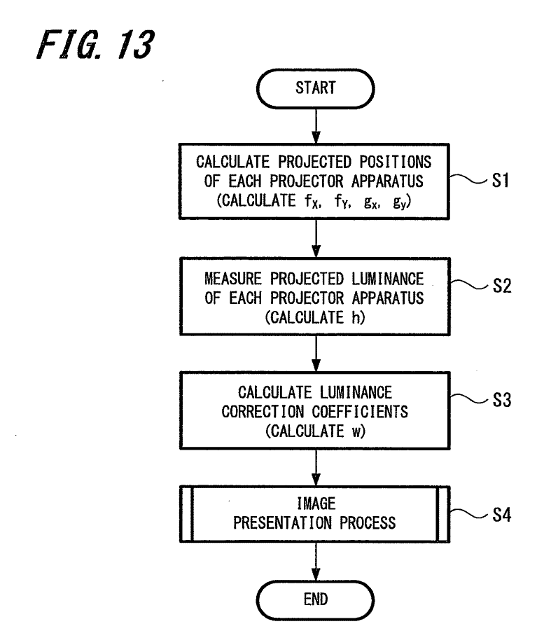

FIG. 13 is a flowchart showing the overall flow of processing by the control apparatus 5 to present an image.

First, the geometry information calculating unit 51 measures the geometry information (fₓ,f_{y},gₓ,g_{y}) that is a projected position of each projector apparatus (step S1). This processing corresponds to the first calibration described earlier.

Next, the luminance information calculating unit 53 calculates the luminance information (h) that is the projected luminance of each projector apparatus (step S2). This processing corresponds to the second calibration described earlier.

After this, the luminance correction coefficient calculating unit 58 generates the luminance correction coefficients w (X,Y,k,p) (step S3). This processing corresponds to the third calibration described earlier.

Finally, the input pixel value calculating unit 60 carries out image presentation processing that adjusts the luminance of the projected image as shown in Expressions (12), (13) (step S4), before the entire processing ends.

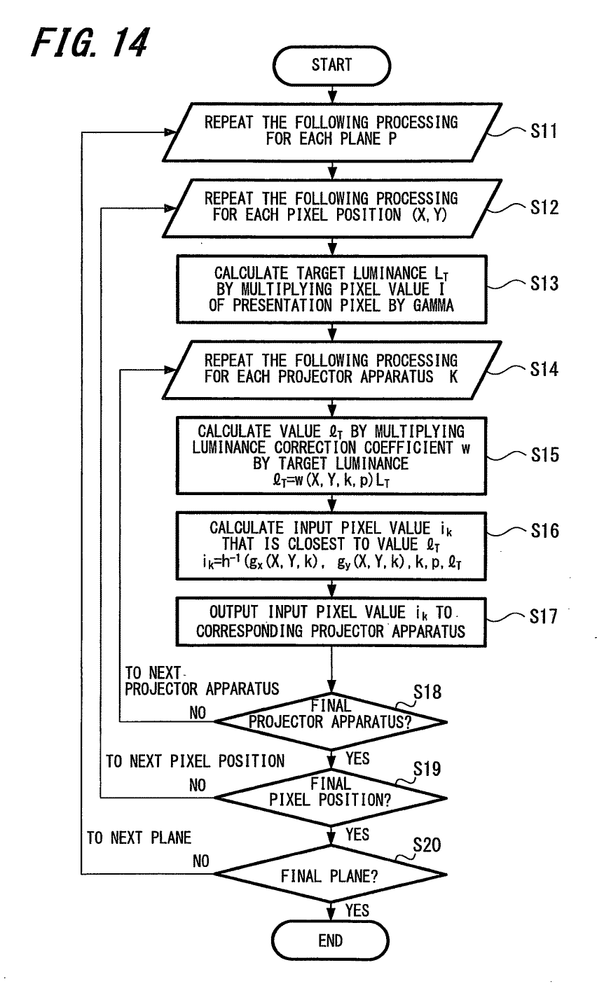

FIG. 14 is a flowchart showing one example of the image presentation processing.

First, the input pixel value calculating unit 60 starts processing for one of the R, G, and B planes (step S11). That is, by cyclically setting the value of p in the order 0, 1, and 2, processing is carried out having selected one of the R plane, the G plane, and the B plane in that order.

Next, the input pixel value calculating unit 60 selects a pixel position (X,Y) (step S12). For example, after the pixel position (0,0), the value on the Y coordinate axis is fixed and the X value is increased, as with the pixel position (1,0). When the X value has reached the end of the image presentation region, one is added to the Y value, the X value is returned to zero, and the X value is thereafter increased by one at a time.

After this, the input pixel value calculating unit 60 multiplies the pixel value I of the presentation image by γ to calculate the target luminance L_{T} (step S13).

Typically, the value of γ is set at around 2.5, but other values may be used. During this processing, as one example, the target luminance is calculated at 800 candelas.

Next, the input pixel value calculating unit 60 selects a projector apparatus (step S14). The projector apparatuses are selected one at a time in a range of k=1 to m. In the present embodiment, four projector apparatuses are selected (the first to fourth projector apparatuses in order, the case where m=4).

After this, the luminance correction coefficient calculating unit 58 calculates, for each selected projector apparatus, a value l_{T} produced by multiplying the target luminance L_{T} by a luminance correction coefficient w (step S15). For example, when the luminance correction coefficient w is 0.125, the value l_{T} is calculated at 100.

Next, the input pixel value calculating unit 60 calculates an input pixel value iₖ that is closest to the calculated value l_{T} (step S16).

In this case, calculation is carried out by inputting Expressions (1), (2) described earlier into Expression (6).

Next, the signal supplying unit 61 outputs the calculated input pixel value iₖ to the corresponding projector apparatus (step S17). Next, it is determined whether the projector apparatus to which the input pixel value iₖ has been outputted is the final projector apparatus (step S18). If the projector apparatus is not the final projector apparatus, one is added to the value of k and the processing returns to step S14. After this, the processing from step S14 to S17 is repeated for the next projector apparatus.

On the other hand, if the projector apparatus is the final projector apparatus, it is determined whether the present pixel position is the final pixel position in the pixels that construct the p^{th} plane (step S19). If the present pixel position is not the final pixel position, the processing returns to step S12. After this, the processing in step S12 to S18 is repeated for the next pixel position.

On the other hand, if the present pixel position is the final pixel position, it is determined whether the present plane is the final plane (p=2) (step S20). When the present plane is not the final plane, one is added to the value of p and the processing returns to step S11. Next, the processing in step S11 to S19 is repeated for the next plane. On the other hand, if the present plane is the final plane, the entire presentation processing for the image to be presented ends.

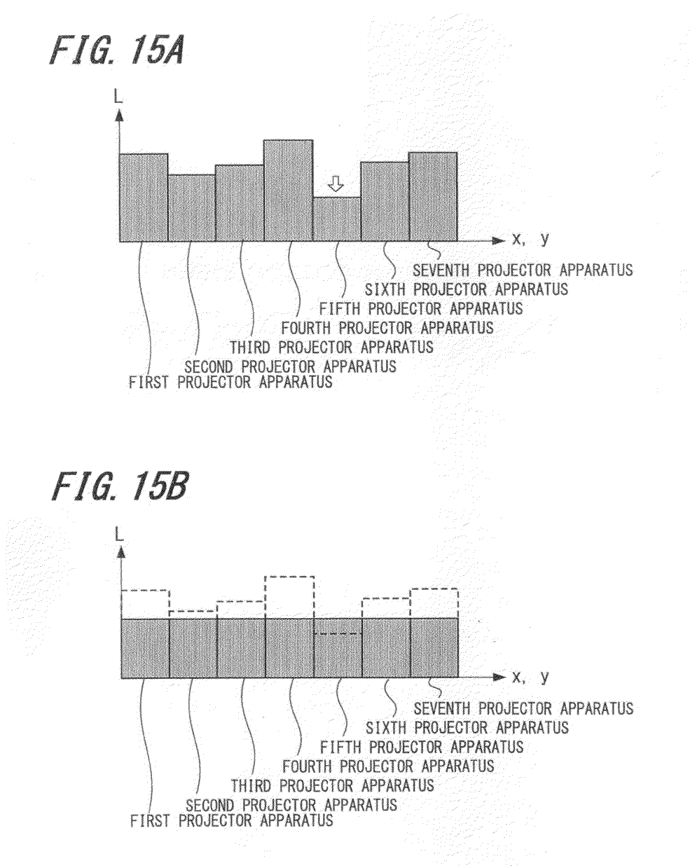

The image projecting system 10 according to the present embodiment aims to display an image projected with high luminance and without fluctuations in luminance. Also, in the image projected using the image projecting system 10, the respective pixels are constructed by light projected by a plurality of projector apparatuses. Here, an example where luminance is corrected by the image projecting system 10 will be described with reference to FIGS. 15A and 15B.

FIGS. 15A and 15B show examples of the luminances (for a white monochrome image) of images projected onto the screen by seven projector apparatuses (referred to as the first to seventh projector apparatuses).

FIG. 15A shows examples of the luminances of images projected by the respective projector apparatuses before the characteristics are matched. In this example, the luminance of the image projected by the fifth projector apparatus is the lowest.

FIG. 15B shows examples of the luminances of images projected by the respective projector apparatuses after the characteristics have been matched. The luminances before the characteristics are matched are shown by broken lines for comparison purposes.

The images projected by the first to seventh projector apparatuses are superimposed with the images projected by the respective adjacent projector apparatuses. This means that the overall luminance is higher than an image projected using existing projector apparatuses. Also, the other projector apparatuses aside from the fifth projector apparatus have a higher luminance than the target luminance. This means that by lowering the output of other projector apparatuses aside from the fifth projector apparatus in accordance with the target luminance, it is possible to achieve a uniform luminance for the entire image projected on the screen 2.

As shown in FIGS. 15A and 15B, the image projecting system 10 does not need to match the luminances of images to the luminance of the image projected by the projector apparatus with the lowest luminance. That is, even if a projector apparatus with low luminance is present, it is possible to supplement insufficient luminance using the images projected by other projector apparatuses.

Next, the result of measuring fluctuations in characteristics (colors) in the region where images projected by the projector apparatuses are superimposed will be described. Here, an example will be described where the color values x, y were measured for a case where four projector apparatuses with the same manufacturer and the same model number were used.

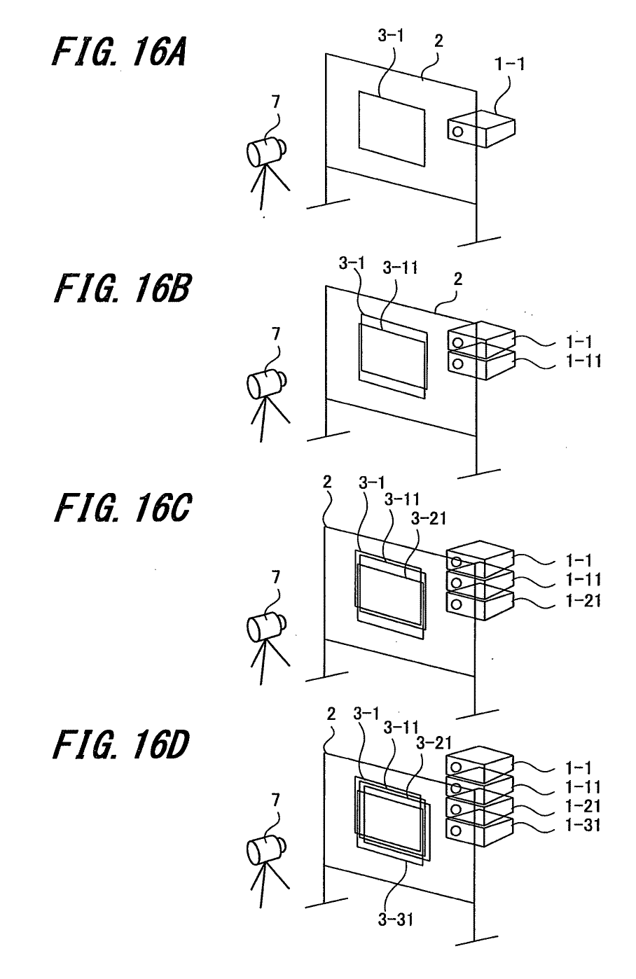

FIGS. 16A to 16D are representations of a color meter-side of the screen when images projected using the projector apparatuses are superimposed. In FIGS. 16A to 16D, the colors in the image projected onto the screen are measured using a color meter 7.

FIG. 16A shows an example of a projected image in the case where one projector apparatus (the projector apparatus 1-1) projects an image onto the screen 2. Here, the image 3-1 is projected onto the screen 2.

FIG. 16B shows an example of projected images in the case where two projector apparatuses (the projector apparatuses 1-1 and 1-11) project images onto the screen 2. Here, the images 3-1 and 3-11 are projected onto and superimposed on the screen 2.

FIG. 16C shows an example of projected images in the case where three projector apparatuses (the projector apparatuses 1-1, 1-11 and 1-21) project images onto the screen 2. Here, the images 3-1 to 3-21 are projected onto and superimposed on the screen 2.

FIG. 16D shows an example of projected images in the case where four projector apparatuses (the projector apparatuses 1-1, 1-11, 1-21 and 1-31) project images onto the screen 2. Here, the images 3-1 to 3-31 are projected onto and superimposed on the screen 2.

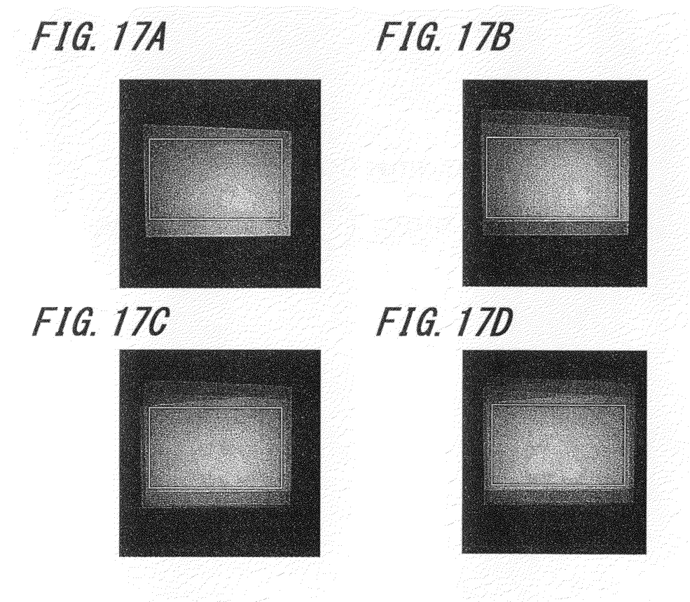

The same image signal ((R, G, B)=(200, 200, 200)) was inputted into every pixel of every projector apparatus shown in FIGS. 16A to 16D. The color meter 7 was used to measure the distribution of the color values x, y in an XYZ color system for the projected images for the respective cases where images were projected by one to four projector apparatuses. The colors inside the white frames in FIGS. 17A to 17D were measured.

FIGS. 17A to 17D show examples of projected images in a case where one to four projector apparatuses project images onto the screen 2.

FIG. 17A shows an example of a projected image in the case where one projector apparatus (the projector apparatus 1-1) projects an image onto the screen 2.

FIG. 17B shows an example of a projected image in the case where two projector apparatuses (the projector apparatuses 1-1 and 1-11) project images onto the screen 2.

FIG. 17C shows an example of a projected image in the case where three projector apparatuses (the projector apparatuses 1-1, 1-11 and 1-21) project images onto the screen 2.

FIG. 17D shows an example of a projected image in the case where four projector apparatuses (the projector apparatuses 1-1, 1-11, 1-21 and 1-31) project images onto the screen 2.

From FIGS. 17A to 17D, it can be understood that even though there are fluctuations in the color and luminance when one projector apparatus is used, by superimposing images projected by a plurality of projector apparatuses, it is possible to make the color and luminance more uniform.

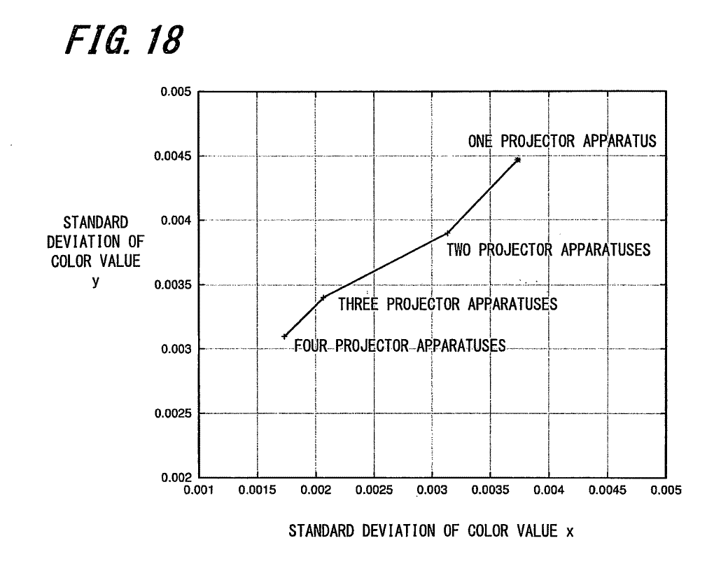

FIG. 18 is a graph in which the standard deviations of the color values x, y in the XYZ color system shown in FIGS. 17A to 17D have been calculated.

From FIG. 18, it can be understood that the distributions of the color values x, y in the XYZ color system converge as the number of projector apparatuses increases (or in other words, as the number of superimposed images increases).

Since the standard deviations of the color values are large when there is one projector apparatus as in FIG. 17A, there are large fluctuations in color. However, it can be confirmed that as the number of projector apparatuses increases, the standard deviations of the color values x,y fall so that there are reduced fluctuations in the colors of the image projected on the screen.

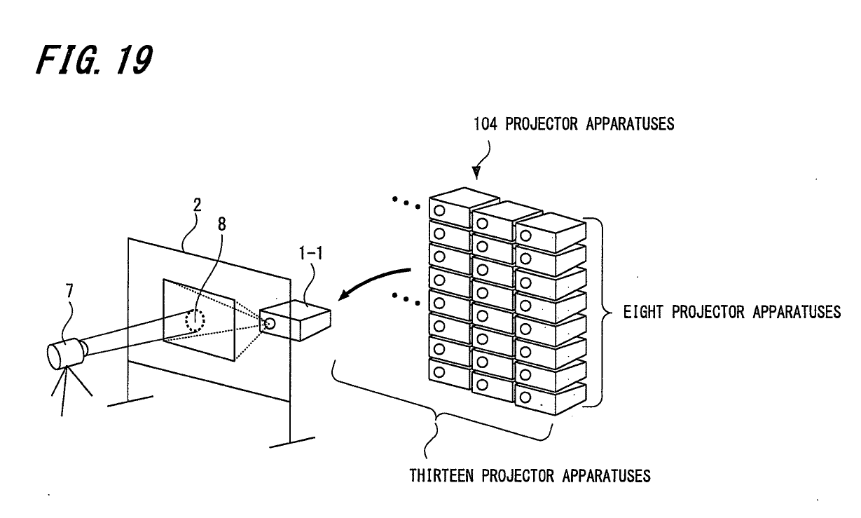

In addition, tests were carried out where a large number of projector apparatuses with the same manufacturer and the same model number were used together to simulate the extent to which colors are made uniform when images projected by adjacent projector apparatuses are superimposed. Such tests and the measurement results thereof will now be described with reference to FIGS. 19 to 24B.

FIG. 19 is a representation showing how colors are measured.

The same image signal ((R, G, B)=(200, 200, 200)) is inputted into every pixel of every projector apparatus.

The color distribution of the projected image was measured for each projector apparatus and the average color in the periphery of the center region 8 of the projected image was calculated.

In the present embodiment, measurement of color was carried out for 104 projector apparatuses.

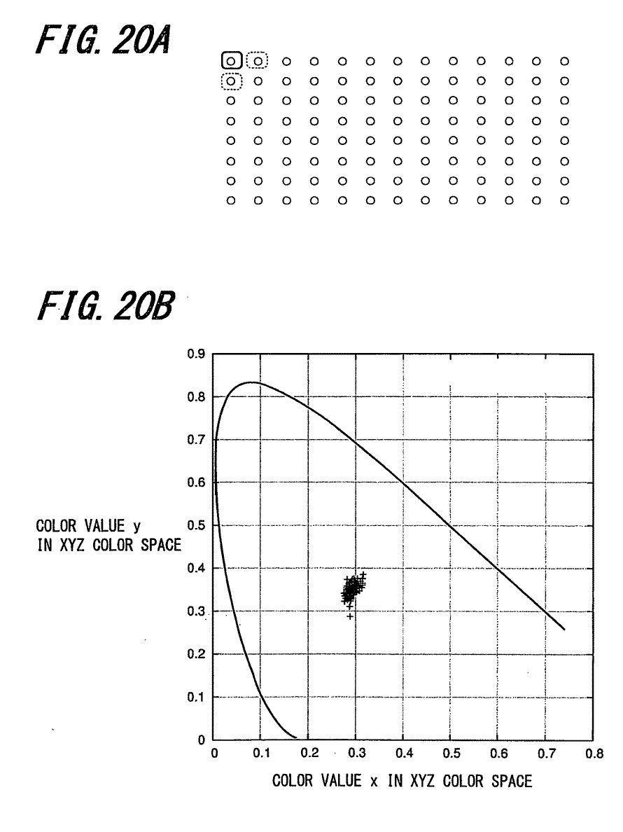

FIGS. 20A to 24B show fluctuations in the color of images projected on the screen 2 by projector apparatuses into which the same image signal is inputted. A state where the projector apparatuses are disposed in a grid is supposed (in other words, the color data of respective projector apparatuses that have been measured is randomly disposed in a grid), and averages for the data of a projector apparatus and the adjacent data thereto were calculated. The standard deviation for all of the average values was also calculated. Such calculations were carried out for four, nine, sixteen, and twenty five adjacent projector apparatuses.

FIGS. 20A and 20B show an example of color values x, y for a case where images are not superimposed.

In FIGS. 20A to 24A, the circles disposed in a grid show the layout positions of the projector apparatuses. In addition, the regions surrounded by solid lines and broken lines show the ranges for which the average values were calculated.

FIG. 20B shows the distribution of the calculated average values.

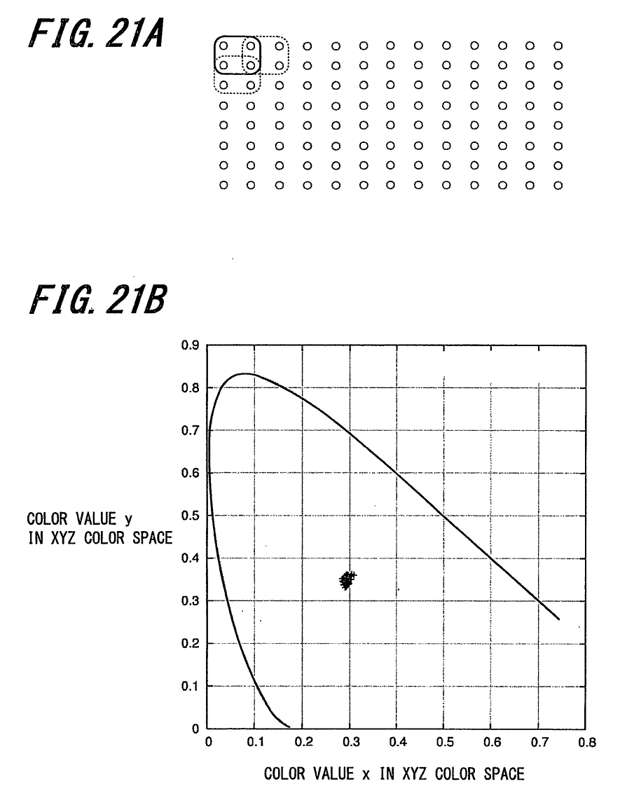

FIGS. 21A and 21B show the result when the average values of the color values x, y were calculated for four adjacent projector apparatuses (FIG. 21A).

FIG. 21B shows the distribution of the average values of the color values x, y.

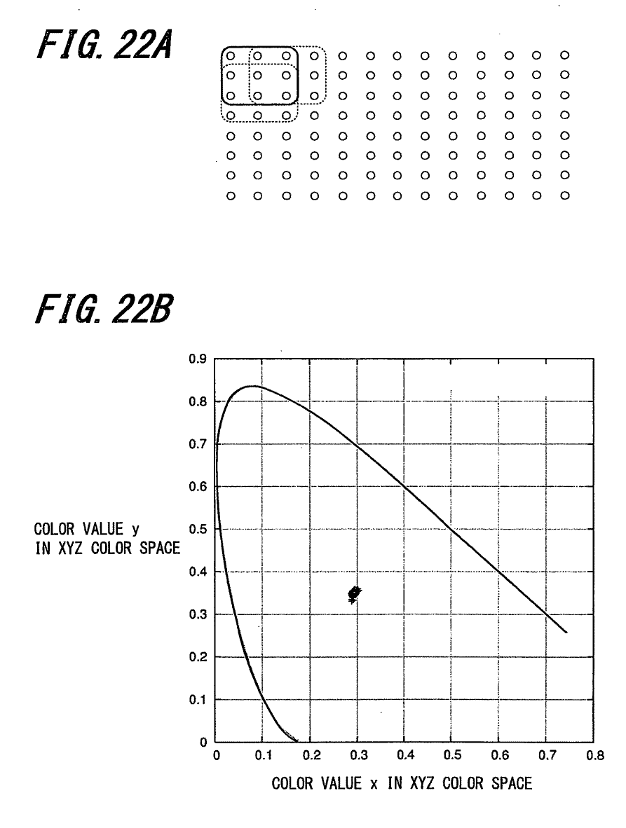

FIGS. 22A and 22B show the result when the average values of the color values x, y were calculated for nine adjacent projector apparatuses (FIG. 22A).

FIG. 22B shows the distribution of the average values of the color values x, y.

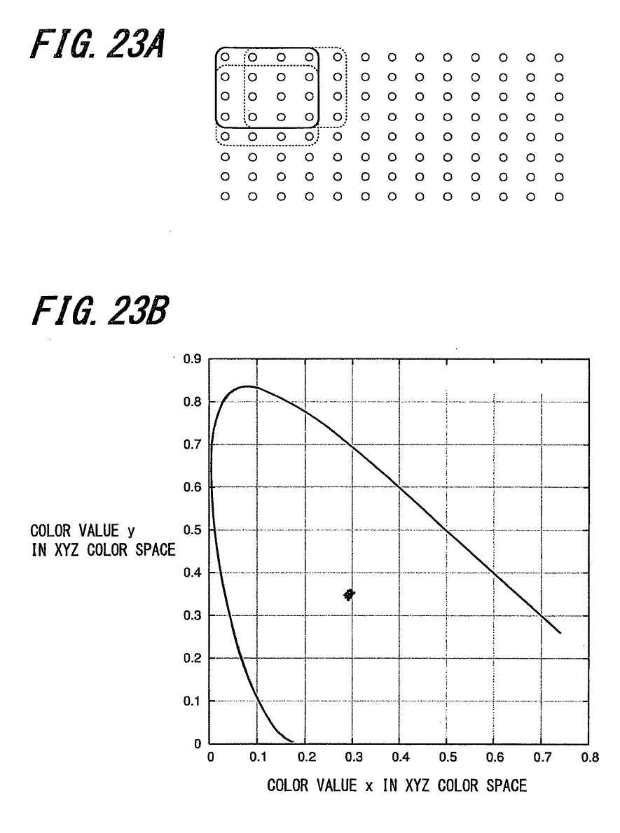

FIGS. 23A and 23B show the result when the average values of the color values x, y were calculated for sixteen adjacent projector apparatuses (FIG. 23A).

FIG. 23B shows the distribution of the average values for the color values x, y.

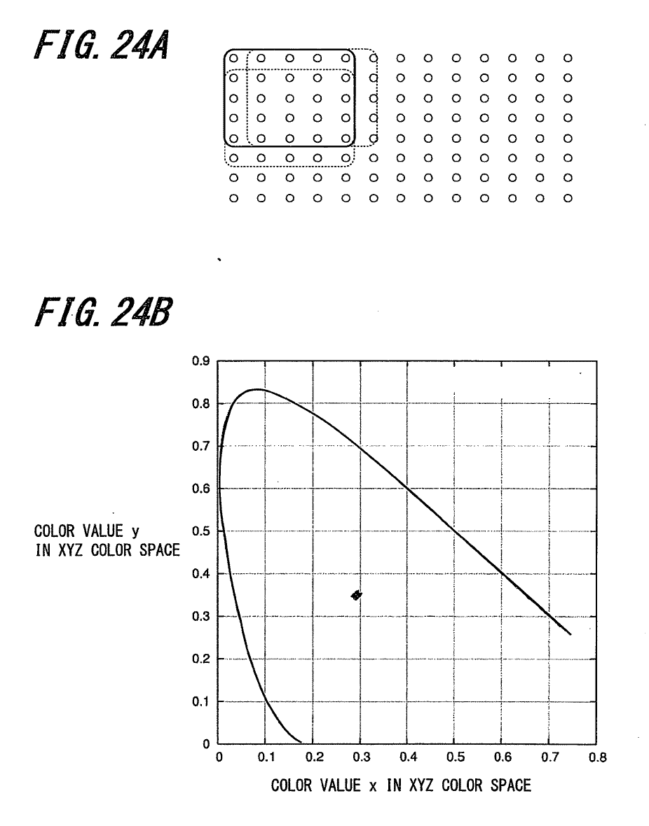

FIGS. 24A and 24B show the result when the average values of the color values x, y were calculated for twenty-five adjacent projector apparatuses (FIG. 24A).

FIG. 24B shows the distribution of the average values for the color values x, y.

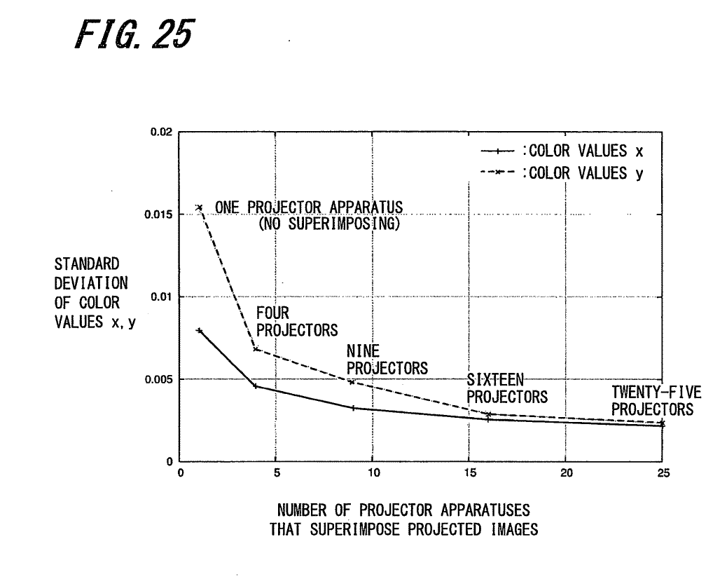

FIG. 25 is a graph showing the relationship between the standard deviations of the color values x, y in a XYZ color system shown in FIGS. 20B to 24B and the number of projector apparatuses whose images are superimposed.

FIG. 25 shows that by superimposing the light from peripheral projector apparatuses, it is possible to reduce the fluctuations in the characteristics of the projector apparatuses. By superimposing images produced by four projector apparatuses in the periphery, the fluctuations in color are reduced to around half. Typically, when n values are taken from a population with a standard deviation of σ, the standard deviation of the averages of n values will satisfy the relationship σ/√n given as a general expression. The result shown in FIG. 25 conforms to this general expression for standard deviations.

In addition, it can be understood that compared to the standard deviation of an image projected by one projector apparatus, when the number of projector apparatuses whose projected images are superimposed increases, the standard deviation of the color values x, y converges on a low value. For this reason, it can be said that when the number of projector apparatuses whose projected images are superimposed increases, there is a reduction in the fluctuations in color.

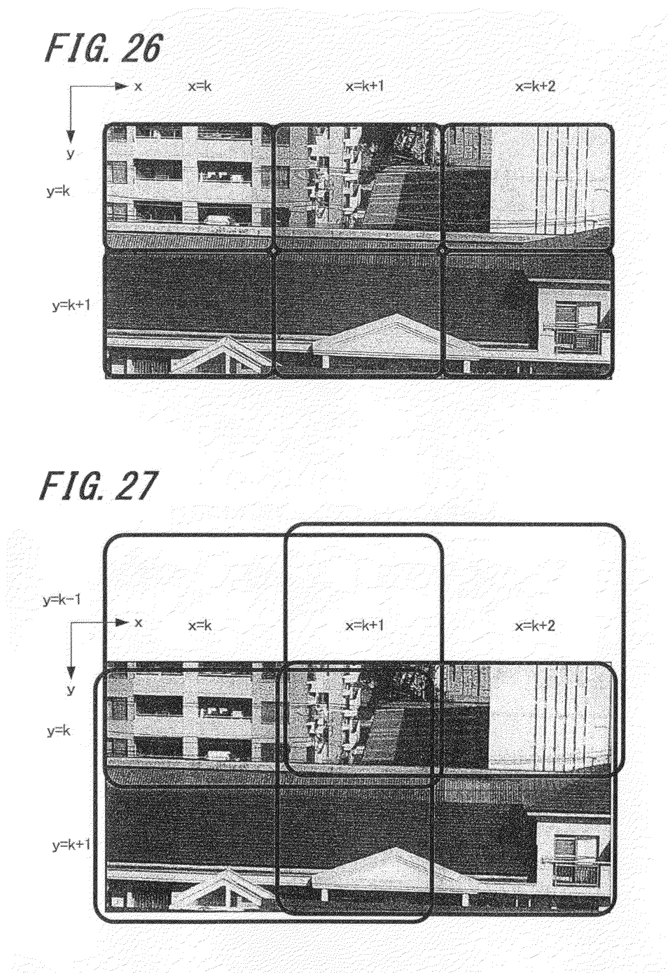

Next, for images actually projected onto the screen 2, a projected image produced by one projector apparatus and a comparative example of projected images superimposed by four projector apparatuses will be described with reference to FIGS. 26 and 27. FIGS. 26 and 27 show how by laying out projector apparatuses and setting the projected images, four different projector apparatuses can project the same image in each region.

FIG. 26 is a photograph showing an image produced when a plurality of projector apparatuses are aligned so that the projected images are not superimposed. For each projector apparatus, no signal processing such as luminance correction is carried out and the input image is projected as it is.

In FIG. 26 and FIG. 27, xy coordinate axes are set for the projected images. In FIG. 26, as one example a region where x=k, y=k is a region where an image is projected by a single projector apparatus. In each of the six regions in FIG. 26, an image projected by one projector apparatus is displayed. From FIG. 26, it can be seen that the luminance and colors of the images displayed in the respective regions are nonuniform.

FIG. 27 is a photograph showing an image produced when the images projected by four adjacent projector apparatuses are superimposed. For each projector apparatus, no signal processing such as luminance correction is carried out and the input image is projected as it is.

In FIG. 27, for convenience, only the region x=k+1, y=k shows a state where projected images produced by the four projector apparatuses are superimposed. However, in the other regions also, an image produced by superimposing the images projected by a projector apparatus assigned to such region and three projector apparatuses adjacent to such projector apparatus is displayed. From FIG. 27, it can be seen that the luminance and colors of the images displayed in the respective regions are uniform.

However, when the images projected by twenty-five projector apparatuses are superimposed, for example, compared to an existing projection method, it is necessary for each individual projector apparatus to project onto a region with a wider area. In this case, the following methods may be used.

(1) The distance (projection distance) between the screen 2 and the projector apparatus is increased.

(2) A wider angle lens is attached to the projector apparatus.

Also, when projected images are superimposed, if the projected positions are not carefully adjusted, the pixels from a plurality of projector apparatuses will be superimposed at displaced positions, resulting in a fall in the perceived resolution of the projected images. This means it is necessary to maintain the resolution of the projected image.

For this reason, with the image projecting system 10 according to the present embodiment, it is possible to preserve the resolution of projected images using the technology described below, for example. For example, when four projector apparatuses are used, images that have been shifted by one-half phase in the horizontal and vertical directions may be projected. Also, to prevent the respective pixels in the projected images from becoming blurred, an inverse response filter may be applied in advance to the input image signals.

The image projecting system 10 according to the first embodiment described above is characterized by superimposing projected light of a plurality of different projector apparatuses at every part of the image on the screen 2. By constructing each pixel of light from a plurality of projector apparatuses, fluctuations in the characteristics (luminance) between projector apparatuses are averaged out. This means that even if there is a projector apparatus with low luminance, it is possible to supplement any insufficiency in luminance using other projector apparatuses used to project light onto the same pixels as the projector apparatus with low luminance. In addition, compared to existing technology, it is possible to use the resources of the projector apparatuses more efficiently. That is, it is possible to project high quality images.

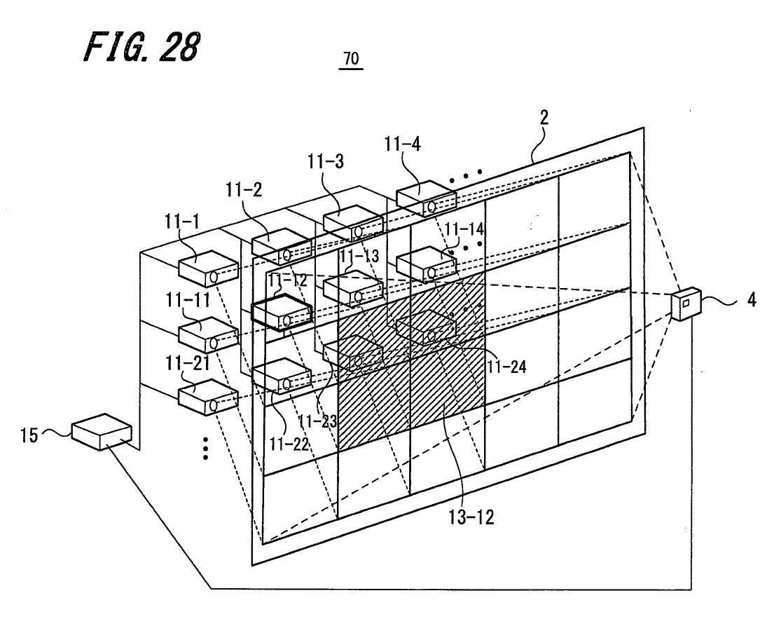

Next, a second embodiment of the present invention will be described with reference to FIGS. 28 to 34D. The present embodiment will also be described by way of an example of an image projecting system 70 that is capable of displaying high-definition images on a screen by superimposing images projected using a plurality of projector apparatuses. However, in the image projecting system 70, when a projector apparatus projects an image onto the screen, a time-division image magnifying unit is used, as described later. Note that in this second embodiment, detailed description of parts that are the same as in the image projecting system 10 according to the first embodiment described above is omitted. Similarly, since the processing that corrects luminance for the respective projector apparatuses is the same as in the image projecting system 10 according to the first embodiment, detailed description thereof is omitted.

FIG. 28 shows an example construction of the image projecting system 70 including a plurality of projector apparatuses. In the image projecting system 70, image signals are supplied to N projector apparatuses 11-1 to 11-N with the same projection performance. In the present embodiment, the case where N=35 projector apparatuses is described.

The image projecting system 70 according to the present embodiment includes N projector apparatuses, the screen 2 that is a display screen for projected images, the observation unit 4 that observes the images projected onto the screen 2, and a control apparatus 15 that receives information observed by the observation unit 4 and supplies image signals to the respective projector apparatuses. However, in the present embodiment, compared to the image projecting system 10 according to the first embodiment described above, processing is carried out with consideration to both the projection range and number of pixels projected by each projector apparatus having effectively quadrupled. In FIG. 28, the image projecting system is simplified and only the projector apparatuses 11-1 to 11-4, 11-11 to 11-14, and 11-21 to 11-24 are shown. Each projector apparatus projects an image onto part of the screen 2 so that as a whole, one image is formed. The image projected by the projector apparatus 11-12 is set as the “projected image 13-12”.

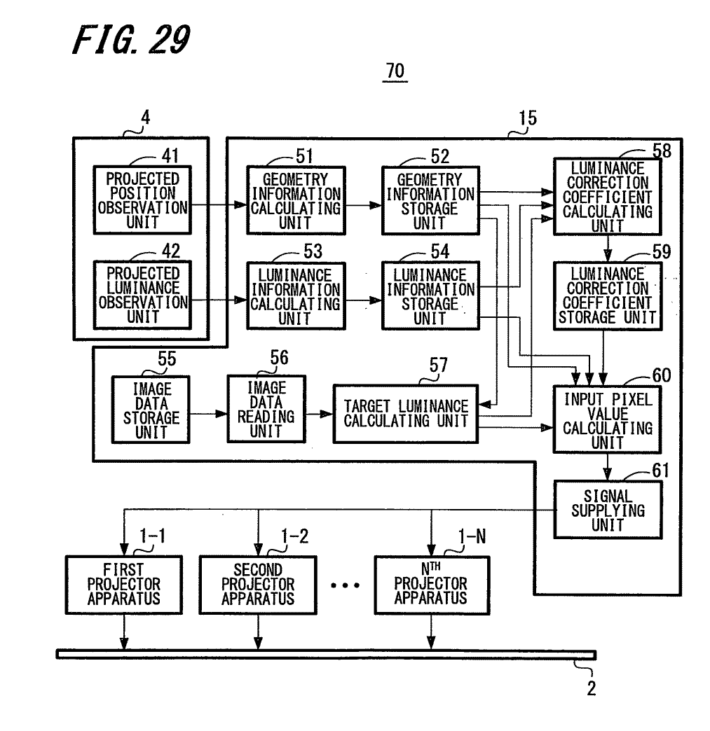

FIG. 29 is a block diagram showing one example of the internal configuration of the image projecting system 70.

In the present embodiment, the image projected on the screen 2 is observed by the observation unit 4, and the control apparatus 15 calculates the luminance and the like of projector apparatuses based on the observed information and supplies image signals to the first projector apparatuses 11-1 to 11-N. This is the same as in the image projecting system 10 in the embodiment described above.

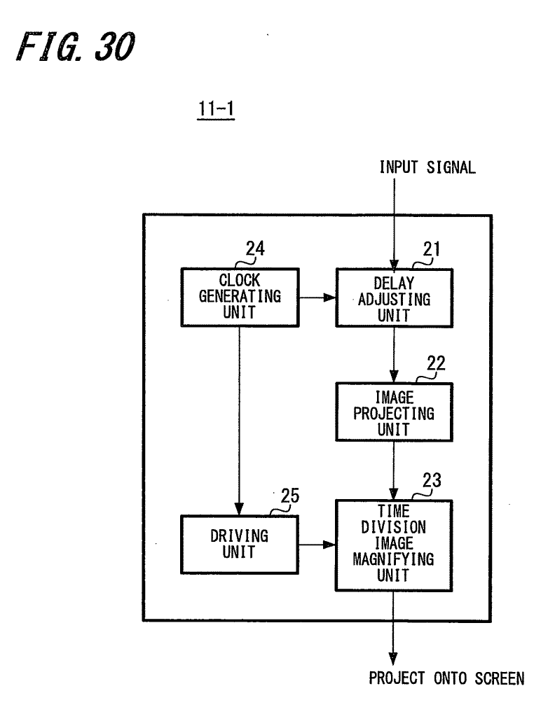

FIG. 30 is a block diagram showing one example of the internal configuration of the projector apparatus 11-1.

The projector apparatus 11-1 includes a delay adjusting unit 21 that adjusts the delay time of an image divided into four based on image signals and control signals supplied from the signal supplying unit 61, an image projecting unit 22 that projects an image, and a time division image magnifying unit 23 that reflects the image projected by the image projecting unit 22 and magnifies an image in each predetermined time period and projects the image onto the screen 2.

The delay adjusting unit 21 delays, by a predetermined time period and corresponding to an order, the outputting of an image signal for a predetermined region in regions produced by dividing the image to be projected onto the screen in a grid.

The image projecting unit 22 outputs a partial image corresponding to the image signal delayed by the delay adjusting unit 21 as projected light.

The time division image magnifying unit 23 includes four mirrors and a shutter mechanism and the four mirrors are rotationally driven by a driving unit 25 such as a motor. The time division image magnifying unit 23 magnifies and projects the partial image from the image projecting unit 22 onto a corresponding region of the screen 2 in order in each delay time period. The timing of the operation of the delay adjusting unit 21 and the time division image magnifying unit 23 is controlled by a clock generating unit 24 that generates a predetermined clock frequency.

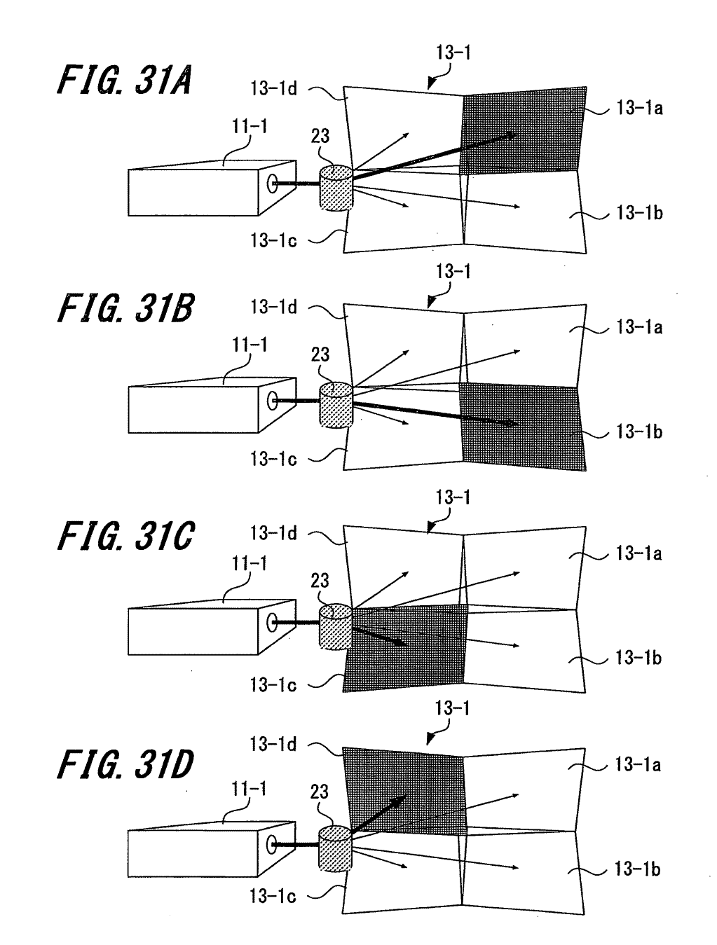

FIGS. 31A to 31D are diagrams showing phase patterns for projecting images.

Each projector apparatus projects a ¼ image at predetermined timing in the image to be projected at each timing. In this example, the projected position of a ¼ image changes in the clockwise direction when the screen 2 is viewed from in front. Here, the position of the projected part is referred to as a “phase pattern”. An example where the projector apparatus 11-1 projects onto the screen 2 will now be described.

FIG. 31A shows an example where an image is projected onto the top right ¼ region 13-1a in the projected image 13-1. This state is referred to as the “first phase pattern”.

FIG. 31B shows an example where an image is projected onto the bottom right ¼ region 13-1b in the projected image 13-1. This state is referred to as the “second phase pattern”.

FIG. 31C shows an example where an image is projected onto the bottom left ¼ region 13-1c in the projected image 13-1. This state is referred to as the “third phase pattern”.

FIG. 31D shows an example where an image is projected onto the top left ¼ region 13-1d in the projected image 13-1. This state is referred to as the “fourth phase pattern”.

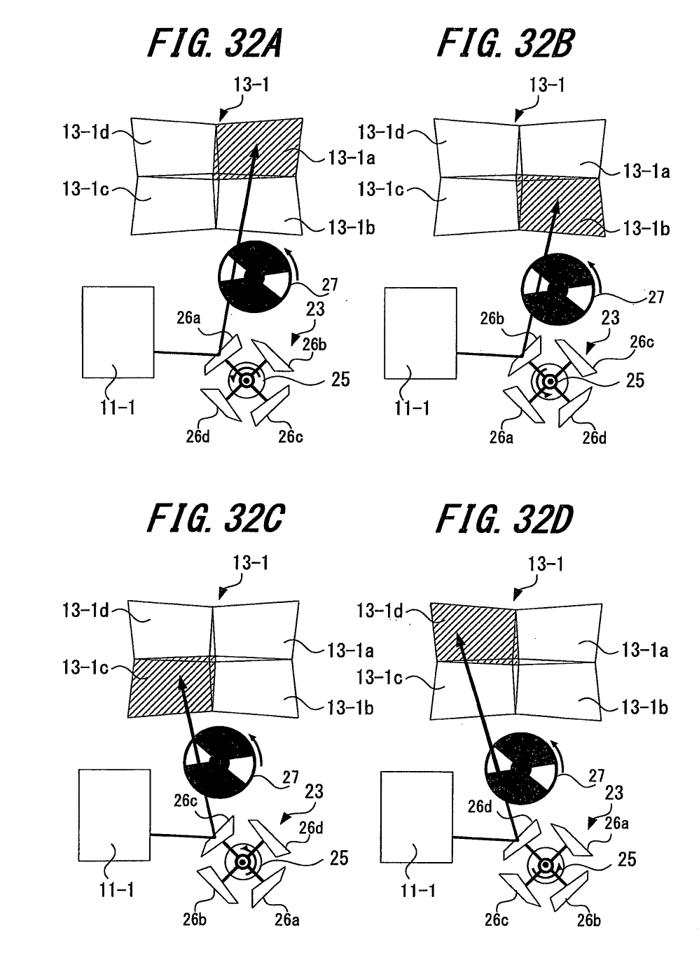

FIGS. 32A to 32D are diagrams where the phase patterns used by the projector apparatus 11-1 shown in FIGS. 31A to 31D are viewed from above.

FIG. 32A shows an example of the first phase pattern. The time division image magnifying unit 23 includes four mirrors 26a to 26d, a motor 25 that rotates the mirrors 26a to 26d, and an optical chopper 27 with a shutter mechanism that switches the ¼ image reflected by the mirrors 26a to 26d. The mirrors 26a to 26d are attached to the motor 25 having adjusted the respective orientations thereof so that projected light is reflected onto the regions assigned to the respective mirrors 26a to 26d. The mirrors 26a to 26d can be rotated in the anticlockwise direction by the motor 25 in accordance with the frame rate (60 Hz) of the input images so as to change the reflection angle of the image projected by the projector apparatus 11-1.

In the first phase pattern, the ¼ image reflected by the mirror 26a is projected onto the region 13-1a.

FIG. 32B shows an example of the second phase pattern.

In the second phase pattern, the ¼ image reflected by the mirror 26b is projected onto the region 13-1b.

FIG. 32C shows an example of the third phase pattern.

In the third phase pattern, the ¼ image reflected by the mirror 26c is projected onto the region 13-1c.

FIG. 32D shows an example of the fourth phase pattern.

In the fourth phase pattern, the ¼ image reflected by the mirror 26d is projected onto the region 13-1d.

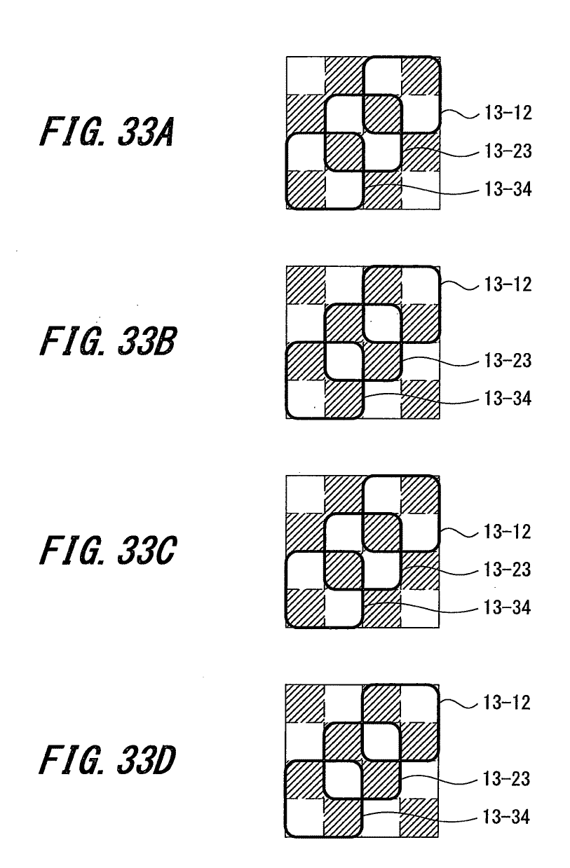

FIGS. 33A to 33D show examples of transitions between the phase patterns for the projector apparatuses.

The projected image 13-12 is an image projected by the projector apparatus 11-12. The projected image 13-23 is an image projected by the projector apparatus 11-23. The projected image 13-34 is an image projected by the projector apparatus 11-34. To prevent the transitional period of the image switching from being visible, the optical chopper 27 releases the shutter in accordance with the frame rate (60 Hz) of the input image to switch between phase patterns. This prevents images from becoming blurred.

FIG. 33A shows an example of the first phase pattern.

FIG. 33B shows an example of the second phase pattern.

FIG. 33C shows an example of the third phase pattern.

FIG. 33D shows an example of the fourth phase pattern.

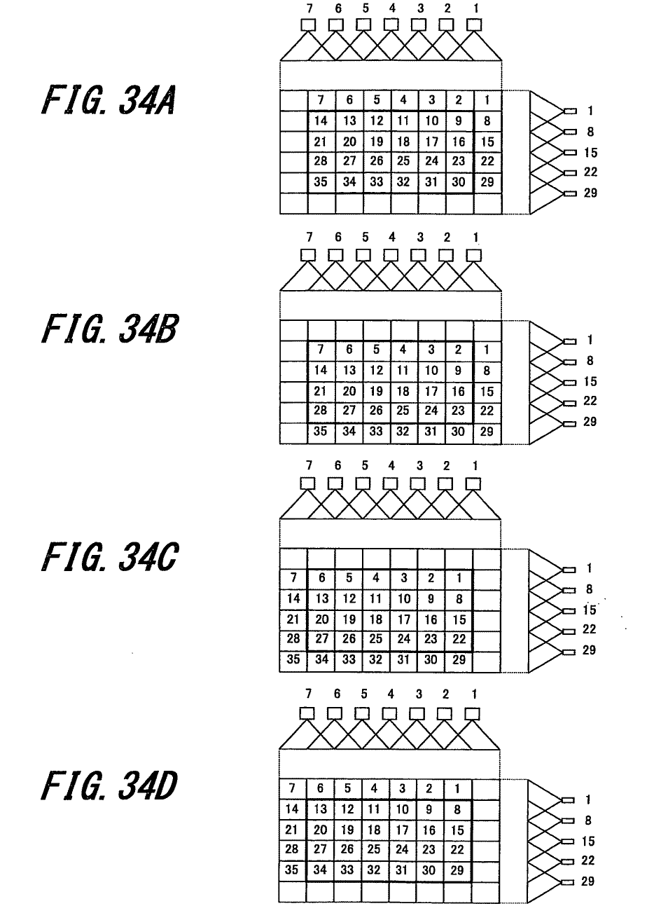

FIGS. 34A to 34D are three-view diagrams showing examples of the phase patterns of the respective projector apparatuses for an image to be projected onto the entire screen 2.

Here, to simplify the explanation, identification numbers for specifying the individual projector apparatuses are assigned in the order of 1, 2, . . . . The image regions onto which images are projected by the projector apparatuses are labeled corresponding to the identification numbers assigned to the projector apparatuses.

FIG. 34A shows an example of the first phase pattern.

FIG. 34B shows an example of the second phase pattern.

FIG. 34C shows an example of the third phase pattern.

FIG. 34D shows an example of the fourth phase pattern.

As shown in FIGS. 31A to 34D, in the image projecting system 70 according to the second embodiment, the positions (phase pattern) of the images projected by the projector apparatuses change at every moment. The phase in which a pixel position of an input pixel value is present is determined and the delay adjusting unit 21 holds the input signal until the timing at which projected images are projected onto such phase. The image signal is then outputted to the image projecting unit 22 in accordance with such timing. By doing so, it is possible to treat the projector apparatuses as projector apparatuses where the number of pixels in the image projected onto the screen 2 has quadrupled.

Also, the image projecting system 70 according to the second embodiment described above switches between phase patterns at extremely short intervals (for example, 1/60 seconds) for each region (in the present embodiment, ¼ of an image). In this way, by switching between phase patterns, on the time axis, images outputted by four different projector apparatuses are projected onto each region. Also, if the speed of switching on the time axis is sufficiently fast for the switching to be imperceptible to the viewer, the same effect as when images are superimposed by four different projector apparatuses can be obtained. Light is projected and superimposed for adjacent projector apparatuses so that each pixel is composed of light from a plurality of different projector apparatuses. This results in the effect that fluctuations in the characteristics of the projector apparatuses can be reduced, which makes it possible to project images of high image quality.

Compared to the image projecting system 10 according to the first embodiment described above, processing is carried out with consideration to the projected range and number of pixels of respective projector apparatuses having effectively quadrupled. Accordingly, compared to the image projecting system 10, the image projecting system 70 is suited to projecting images onto a large screen.

The image projecting systems according to the first and second embodiments described above are characterized by being constructed so that projected light of different projector apparatuses is superimposed at every part of the image on the screen 2. Compared to existing technology, it is possible to provide a high-quality image on a large screen. Even if one or more projector apparatuses breaks down or stops during the presentation of images, there is a reduced risk of part of the presented image becoming blank (i.e., no image being outputted in such part). By using the image projecting system 10 according to the embodiment described above, the vulnerability of an image projecting system to breakdown of a projector apparatus which was a problem in the past is solved. For example, even when one projector apparatus breaks down or stops, some information, even if incomplete (such as an image with reduced luminance), will be presented on the screen 2. This is because each pixel is composed of light projected by a plurality of projector apparatuses. This means that the problem of nothing being presented in a region where light was projected by a projector apparatus that has broken down is avoided. As a result, there is the effect that images can be continuously presented.

Also, although an image projecting system where light is shone onto the entire screen to supplement luminance is known from the past, in such system, the output of the light source lamp of the apparatus that shines light onto the screen needs to be increased as the size of the screen increases. When a light source lamp with a large output is used, there is not only an increase in power consumption but the operating life of the light source lamp itself also tends to decrease. There is also no way to increase the resolution. However, with the image projecting system 10 according to the embodiment described above, the layout of the projector apparatuses is adjusted so that the width of the images projected by adjacent projector apparatuses is equal to an integer multiple of the widths of the adjacent projector apparatuses. The luminance of the image projected onto the screen is supplemented by having a plurality of adjacent projector apparatuses project images onto the screen. Also, by changing the luminance correction coefficients w, it is possible to optionally change the allocations of luminance assigned to the respective projector apparatuses with regard to the target luminance. This means that the output of the light source lamp may be the same for every projector apparatus. Since the luminance can be supplemented using a plurality of projector apparatuses even when the output of the light source lamps have been lowered, there is an effect that it is possible to increase the operating life of the light source lamps.

Also, since it is possible to project a high-definition image with little fluctuations in luminance onto a large screen, it is possible for a number of people to view the same image (for example, an image showing the structure of DNA). One group of projector apparatuses (for example, four projector apparatuses) can be laid out in a repeating pattern. Since there are no limits on the size or shape of the screen (i.e., the screen does not need to be rectangular), it is possible to apply an embodiment of the present invention to applications such as projecting images in a home theatre or commercially. By superimposing a plurality of projected images, it is possible to present large-screen, natural-looking images on the entire screen 2 without visible joins between adjacent projected images.

Note that although examples where the projector apparatuses are laid out in a tile pattern have been described for the image projecting systems according to the first and second embodiments described above, the projector apparatuses can be laid out in other patterns. For example, the projector apparatuses may be laid out so as to be shifted by half of the width of adjacent projector apparatuses in the vertical direction.

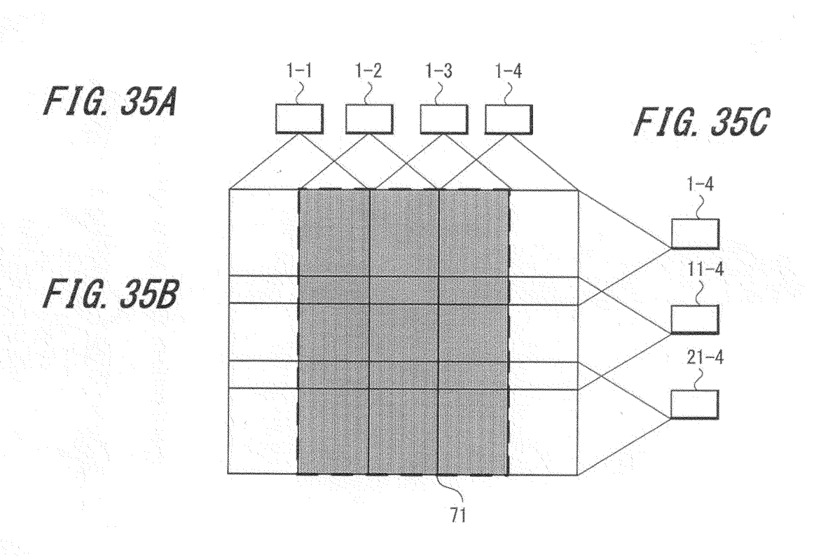

FIGS. 35A to 35C are diagrams showing a modification to the layout of the projector apparatuses.

In the horizontal direction (x direction), projector apparatuses are laid out as in an image projecting system according to an embodiment of the present invention. In the vertical direction (y direction), an existing layout of projector apparatuses is used (where only parts of the projected images are superimposed). The horizontal width of the projected regions of the projector apparatuses are n times (where n is an integer of 2 or higher) the interval between adjacent projector apparatuses in the horizontal direction. It is also possible to use a layout pattern where a layout according to an embodiment of the present invention is used in the vertical direction and an existing layout is used in the horizontal direction.

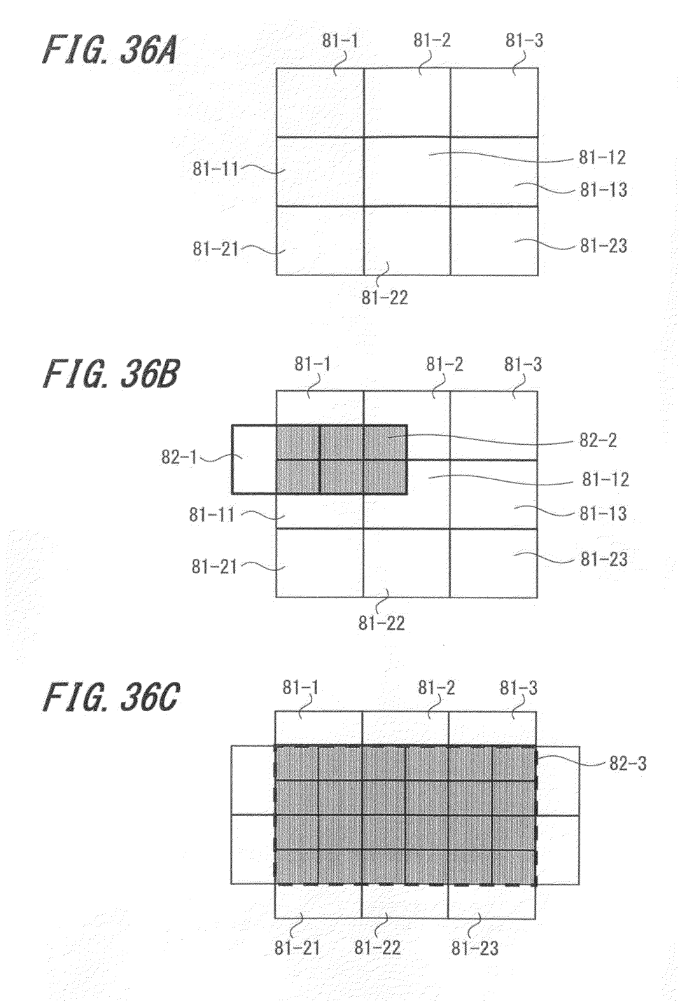

FIGS. 36A to 36C are diagrams showing a modification to the layout of projected images of projector apparatuses.

FIG. 36A shows an example where projected images of respective projector apparatuses are aligned without superimposing projected images and without gaps on the screen 2. The images projected by the projector apparatuses are shown as the projected images 81-1 to 81-3, 81-11 to 81-13, and 81-21 to 81-23.

FIG. 36B shows an example where the projected image of another projector apparatus is superimposed at an intersection of four projector images.

As one example, the projected image 82-2 is projected at the intersection between the projected images 81-1, 81-2, 81-11, and 81-12.

FIG. 36C shows an example where the projected images shown in FIG. 36B have been laid out across the entire region.

In the present embodiment, the range surrounded by the broken line is used as the image projection region 82-3 that can be seen by the user. At any pixel position within the range of the image projection region 82-3, the projected image is formed of light projected by two different projector apparatuses.

In a state where a projected plane of a projector apparatus is not parallel to the screen surface (i.e., when the projector apparatus is not perpendicular to the screen), it is necessary to carry out distortion correction in advance so that the projected image of the projector apparatus becomes rectangular. By carrying out distortion correction, images can be projected as rectangular images, even if the images are projected far from the screen without such correction.

Note that the series of processing in the embodiments described above can be carried out by hardware and can also be carried out by software. When the series of processing is carried out by software, a program that constructs such software is installed into a computer in which dedicated hardware is incorporated or a program that constructs the desired software is installed into a general-purpose personal computer, for example, that is capable of various types of functions when various types of program are installed and then executed.

An embodiment of the present invention may also be accomplished by supplying a system or an apparatus with a recording medium in which a program code of software which realizes the functions of the above described embodiments is recorded, and causing a computer (or a control apparatus such as a CPU) of the system or apparatus to read out and execute the program code stored in the recording medium.

As examples of the recording medium for supplying the program code, it is possible to use a floppy disk, a hard disk, an optical disk, a magneto-optical disk, a CD-ROM, a CD-R, a magnetic tape, a nonvolatile memory card, a ROM or the like.

Further, the functions of the above described embodiments may be accomplished not only by executing program code read out by a computer, but also by causing an OS (operating system) or the like which operates on the computer to perform a part or all of the actual processing based on instructions of the program code.

An embodiment of the present invention includes both processing where the steps in a program that construct such software are carried out as a time series in the order given in this specification and processing where such steps are not necessarily carried out as a time series and are carried out separately or in parallel.

Note that the present invention is not limited to the embodiments of the invention described above and a variety of constructions can be used without departing from the scope of the invention.

It should be understood by those skilled in the art that various modifications, combinations, sub-combinations and alterations may occur depending on design requirements and other factors insofar as they are within the scope of the appended claims or the equivalents thereof.

What is claimed is:

1. An image projecting system comprising:
a plurality of projector apparatuses that project images based on inputted image signals onto a screen so that the images are displaced relative to one another by a predetermined amount and superimposed;
an observation apparatus that observes luminance of an image region composed of the images projected onto the screen by the plurality of projector apparatuses; and
a control apparatus that supplies the plurality of projector apparatuses with the image signals having an adjusted luminance value of each pixel for an image projected by each projector apparatus based on an observation result of the observation apparatus,
wherein a pixel in the image region is produced by superimposing corresponding pixels in images projected by adjacent projector apparatuses in the plurality of projector apparatuses, and
wherein a length of one edge of each image projected is n times a distance between the adjacent projector apparatuses (where n is an integer of two or higher).

2. The image projecting system according to claim 1,
wherein the observation apparatus includes:
a projected position observation unit configured to observe a projected position of a pixel for the image region on the screen;
a position information calculating unit configured to calculate, as position information, a position of each pixel for the image projected by each projector apparatus from the projected position of each pixel for the image region observed by the projected image observation unit;
a luminance observation unit configured to observe the luminance of the image region on the screen;
a luminance information calculating unit configured to calculate, as luminance information, a luminance of each pixel for the image region on the screen from the luminance of the image region observed by the luminance observation unit and the position information;
a luminance correction coefficient calculating unit configured to set, as a target luminance, a luminance that is a target for the image region and determine, as luminance correction coefficients, allocations of the luminance for images projected by each projector apparatus for the target luminance;
a pixel value calculating unit configured to determine a target projected luminance for an image projected by each projector apparatus based on the luminance correction coefficients calculated by the luminance correction coefficient calculating unit and the target luminance, and calculate a pixel value of each pixel for the image projected by each projector apparatus based on the determined target projected luminance, the position information, and the luminance information; and
a signal supplying unit configured to generate image signals based on the pixel values calculated by the pixel value calculating unit and supply the image signals to the projector apparatuses.

3. The image projecting system according to claim 2,
wherein for a pixel in the image region on the screen, the allocations of luminance for each projector apparatus that projects onto the pixel are changed based on the luminance correction coefficients.

4. The image projecting system according to claim 3,
further comprising a target luminance calculating unit configured to determine the target luminance,
wherein the target luminance calculating unit sets the target luminance within a range of a maximum value and a minimum value of luminance of images projected by the plurality of projector apparatuses.

5. The image projecting system according to claim 4,
wherein each projector apparatus includes:
a delay unit configured to delay output of image signals, which respectively correspond to predetermined regions in n² regions formed by dividing an image projected onto the screen in a grid, in order by a predetermined time period;
an image projecting unit configured to output partial images corresponding to the image signals delayed by the delay unit; and
an image magnifying unit configured to magnify and project the partial images from the image projecting unit onto a corresponding region of the screen in order in each time period.

6. The image projecting system according to claim 3,
wherein the projector apparatuses project images onto the screen so that the projected images are displaced by 1/n times the length of one edge of the projected images.

7. The image projecting system according to claim 1,
wherein the plurality of projector apparatuses are laid out in a grid at predetermined intervals.

8. An image projecting method comprising the steps of:
projecting images based on inputted image signals onto a screen using a plurality of projector apparatuses so that the images are displaced relative to one another by a predetermined amount and superimposed;
observing luminance of an image region composed of the images projected onto the screen by the plurality of projector apparatuses; and
supplying the plurality of projector apparatuses with the image signals having an adjusted luminance value of each pixel for an image projected by each projector apparatus based on an observation result,
wherein a pixel in the image region is produced by superimposing corresponding pixels in images projected by adjacent projector apparatuses in the plurality of projector apparatuses, and
wherein a length of one edge of each image projected is n times a distance between the adjacent projector apparatuses (where n is an integer of two or higher).

9. A computer program comprising computer program instructions which when executed by a computer performs an image projecting method, the method comprising steps of:
projecting images based on inputted image signals onto a screen using a plurality of projector apparatuses so that the images are displaced relative to one another by a predetermined amount and superimposed;
observing luminance of an image region composed of a plurality of images projected onto the screen by the plurality of projector apparatuses; and
supplying the plurality of projector apparatuses with the image signals having an adjusted luminance value of each pixel for an image projected by each projector apparatus based on an observation result,
wherein a pixel in the image region is produced by superimposing corresponding pixels in images projected by adjacent projector apparatuses in the plurality of projector apparatuses, and
wherein a length of one edge of each projected image is n times a distance between the adjacent projector apparatuses (where n is an integer of two or higher).

10. A recording medium on which the computer program according to claim 9 is stored.
